(19) United States
(12) Patent Application Publication
(10) Pub. No.: US 2012/0225613 A1
(43) Pub. Date: Sep. 6, 2012

(54) APPARATUS AND MEDIUM FOR DRY CLEANING

(76) Inventors: Akihiro Fuchigami, Kanagawa (JP); Yoichi Okamoto, Kanagawa (JP); Tatsuya Satoh, Tokyo (JP)

(21) Appl. No.: 13/505,383

(22) PCT Filed: Sep. 15, 2010
(86) PCT No.: PCT/JP2010/066472

§ 371 Date: May 1, 2012

(30) Foreign Application Priority Data
Nov. 11, 2009 (JP) 2009-257958

(51) Int. Cl. B24C 7/00; C09K 3/14

(52) U.S. Cl. 451/89; 51/298

(57) ABSTRACT

A cleaning apparatus includes a cleaning tank having a space to contain flexible flake cleaning media, a cleaning target object holding unit holding a cleaning target object having adherent substances inside the cleaning tank, a gas flow generator unit generating a gas flow to move the cleaning media toward the cleaning target object such that the cleaning media contact the cleaning target object to remove the adherent substances from the cleaning target object, and an adherent substance collection unit moving the gas flow to collect the adherent substances removed from the cleaning target. A surface of the cleaning medium includes abrasive grains to remove the adherent substances from the cleaning target object by causing the surface of the cleaning medium having the abrasive grains to slide on the cleaning target object while the surface of the cleaning medium having the abrasive grains is in contact with the cleaning target object.

### TECHNICAL FIELD

The invention generally relates to an apparatus and a medium for dry cleaning by abrading an adherent substance such as coating adhering to a surface of an object subject to cleaning. More specifically, the invention pertains to an apparatus and a medium suitable for removing toner thermally adhering to components or rust formed on metallic gears used for a high-speed engine of the electrophotographic apparatuses in reusing or recycling the electrophotographic apparatuses such as copiers or laser printers.

### BACKGROUND ART

In realizing a resources recycling oriented society, used products or used units such as copiers, facsimile machines, and printers that are collected from users are dissembled, cleaned, and reassembled such that the used products or used units collected from the users are recycled or reused in a proactive manner. The used products include components contaminated by toner adhering to the components, paper powder thickly adhering to the components due to heat, or rust forming in the components. It is generally difficult to remove these adherent substances by a simple cleaning method. Accordingly, in related art technologies, in order to reuse such used components, a stripping cleaning process, a blasting process or a polishing process is used for removing such adherent substances from the components. The stripping cleaning process removes the adherent substances by swelling them with a stripping liquid.

The blasting process includes blasting abrasive grains together with a compressed gas such as compressed air over surfaces of the used components subject to recycling or the used products subject to recycling. The blasting process is widely used in various cleaning methods such as cleaning surfaces, removing rust, and deburring because it is easily employed for the cleaning of the used components or used products that have complicated structures compared to the abrading of the used components or used products with abrasive paper, an abrasive cloth, and a grindstone. Further, in order to mirror finish or smooth surfaces of the used components or used products without pear-skin finishing their surfaces, there is proposed a blasting process in which elastic abrasive grains are applied at angles slanted to the surfaces of the used products. With this blasting process, the applied elastic abrasive grains first collide with the surfaces of the used products and then slide on them, thereby mirror finishing or smoothing the surfaces of the used products.

The polishing process includes removing the adherent substances by abrading the object (e.g., used product) subject to cleaning with abrasive paper, or a grindstone. An example of the abrasive paper includes an abrasive film obtained by making abrasive grains to adhere to a substrate such as paper or a plastic film that are used as sand paper or lapping tape in the related art technologies. Japanese Laid-Open Patent Application Publication No. 09-212856 (also referred to as Patent Document 1) discloses a related art blasting technology in which compressed air is blasted from the back of the lapping tape to improve a lapping effect.

Further, the applicant of the invention discloses cleaning technologies in which flexible thin flake cleaning media are used as cleaning media (see Japanese Laid-Open Patent Application Publication No. 2007-245079 also referred to as Patent Document 2, Japanese Laid-Open Patent Application Publication No. 2008-149253 referred to as Patent Document 3, and Japanese Laid-Open Patent Application Publication No. 2009-45613 referred to as Patent Document 4). In these technologies, the flexible thin flake cleaning media are moved by the gas flow in a direction toward the object subject to cleaning to collide with the adherent substances adhering to the surface of the object, thereby removing the adherent substances from the object. In these technologies, since the flexible thin flake cleaning media are used as cleaning media, they are moved by the gas flow in the direction of the object subject to cleaning such that the flexible thin flake cleaning media reach projected portions and recessed portions in a large surface area of the object to be cleaned at high speeds.

However, the stripping cleaning process disclosed by the related art blasting technology in Patent Document 1 in which the stripping liquid is used for cleaning the object may additionally require a drying process or a discharging process. Accordingly, it may be difficult to lower the recycling cost.

Further, the blasting process disclosed by the above related art blasting technologies may also require an additional cleaning process for cleaning the blast material or the abrasive grains after the blasting process, a discharging process for discharging waste liquid, and a drying process for drying the object after cleaning, which result in high energy consumption or environmental impact. Accordingly, it may also be difficult to lower the recycling cost. Further, in order to use the elastic abrasive grains in the blasting process, particle sizes of the elastic abrasive grains need to be further reduced for adequate use in cleaning minute recesses and projections in the surface of the object. Thus, it may generally be difficult to reuse these minute abrasive grains due to an increase in the running cost.

Further, the polishing process using an abrasive member such as the abrasive paper or the grindstone is capable of cleaning an object subject to cleaning if the object has a simple structure, because the abrasive members have relatively large sizes with limited surface shapes and are arranged at predetermined positions. Accordingly, it may be difficult to remove rust on the gears having projections and recesses. Note that the technology disclosed in Patent Document 1 is aimed at improving the lapping effect, so that the disclosed technology in Patent Document 1 still has the above-described problems.

Further, the technologies disclosed in Patent Documents 2 through 4 remove the adherent substances from the object by scraping them off with cleaning media or flapping them with the cleaning media, which may have limitations for the removal of the adherent substances strongly adhering to the object.

### SUMMARY OF THE INVENTION

Accordingly, it is a general object of the present invention to provide a novel and useful apparatus, and medium capable of efficiently cleaning an object having a complicated structure even if adherent substances are strongly adhering to the surface of the object having a complicated structure subject to cleaning or rust formed on the surface of the object having a complicated structure subject to cleaning.

In one embodiment, there is provided a cleaning apparatus that includes: a cleaning tank having a space to contain plural flexible flake cleaning media; a cleaning target object holding unit configured to hold a cleaning target object having adherent substances adhering thereto inside the cleaning tank; a gas flow generator unit configured to generate a gas flow to move the plural flexible flake cleaning media toward the cleaning target object such that the plural flexible flake cleaning media contact the cleaning target object to remove the adherent substances from the cleaning target object; and an adherent substance collection unit configured to move the gas flow to collect the adherent substances removed from the cleaning target object. In the cleaning apparatus, at least one surface of each of the flexible flake cleaning media includes abrasive grains to remove the adherent substances from the cleaning target object by causing the surface of the flexible flake cleaning medium having the abrasive grains to slide on the cleaning target object while the surface of the flexible flake cleaning medium having the abrasive grains is in contact with the cleaning target object.

In another embodiment, there is provided a cleaning apparatus that includes: a cleaning tank having a space to contain plural flexible flake cleaning media; a cleaning target object holding unit configured to hold a cleaning target object to which an adherent substances adhere inside the cleaning tank; a gas flow generator unit configured to generate a gas flow to move the plural flexible flake cleaning media toward the cleaning target object such that the plural flexible flake cleaning media contact the cleaning target object to remove the adherent substances from the cleaning target object; and an adherent substance collection unit configured to move the gas flow to collect the adherent substances removed from the cleaning target object. In cleaning apparatus, at least one surface of each of the flexible flake cleaning media includes abrasive grains to remove a part of the adherent substances from the cleaning target object by causing the surface of the flexible flake cleaning medium having the abrasive grains to slide on the cleaning target object while the surface of the flexible flake cleaning medium having the abrasive grains is in contact with the cleaning target object, and a part of the adherent substances is removed from the cleaning target object by allowing the flexible flake cleaning media to collide with the cleaning target object.

In another embodiment, there is provided a cleaning medium that includes a flexible flake medium and abrasive grains provided in at least one surface of the flexible flake medium, where the flexible flake medium having at least one surface provided with the abrasive grains moves toward a cleaning target object having adherent substances arranged in a space to remove the adherent substances from the cleaning target object while the flexible flake medium having at least one surface provided with the abrasive grains is in contact with the cleaning target object having the adherent substances.

### BRIEF DESCRIPTION OF DRAWINGS

Other objects and further features of embodiments will be apparent from the following detailed description when read in conjunction with the accompanying drawings, in which:

FIGS. 1A and 1B are a sectional front view and a sectional side view each illustrating a configuration of a cleaning apparatus according to a first embodiment;

FIG. 2 is a sectional side view illustrating a configuration of a cleaning medium according to a first embodiment;

FIG. 3 is a sectional side view illustrating movement of the cleaning medium according to the first embodiment;

FIG. 4 is a sectional side view illustrating movement of the cleaning medium according to the first embodiment when the cleaning medium moves toward uneven portion of a cleaning target object;

FIG. 5 is a graph illustrating a result of an experiment;

FIG. 6 is a sectional side view illustrating a configuration of a cleaning medium according to a second embodiment;

FIG. 7 is a sectional side view illustrating a configuration of a related art cleaning medium;

FIGS. 8A and 8B are sectional side views illustrating a configuration of a cleaning medium according to a third embodiment;

FIG. 9 is a sectional side view illustrating a configuration of another related art cleaning medium;

FIGS. 10A is a perspective view, and 10B and 10C are sectional side view illustrating a configuration of a cleaning medium according to a fourth embodiment;

FIGS. 11A through 11E are sectional side views illustrating movements of the cleaning medium according to the fourth embodiment;

FIGS. 12A and 12B are views illustrating a configuration of a cleaning apparatus according to a second embodiment;

FIGS. 13A through 13E each include a front view and a sectional side view illustrating a configuration of a cleaning medium according to a fifth embodiment;

FIG. 14 includes a perspective view and a side view illustrating a configuration of a cleaning medium according to a sixth embodiment;

FIG. 15 is a perspective view illustrating a configuration of a cleaning medium according to a seventh embodiment;

FIGS. 16A, 16B, and 16C are perspective views illustrating configurations of cleaning media according to an eighth embodiment;

FIGS. 17A through 17D are perspective views illustrating configurations of cleaning media according to a ninth embodiment;

FIG. 18 include diagrams illustrating scattering movements of the cleaning media according to the third embodiment when a rotational force is applied thereto;

FIG. 19 is an explanatory diagram illustrating a method in which the cleaning media are scattered while rotating;

FIG. 20 is an explanatory diagram illustrating a projection device configured to scatter the cleaning media according to the third embodiment while rotating the cleaning media;

FIGS. 21A and 21B are views illustrating a configuration of a cleaning apparatus according to a third embodiment;

FIGS. 22A and 22B are views illustrating a configuration of a cleaning apparatus according to a fourth. embodiment; and

FIG. 23 is a projection device provided in the cleaning apparatus according to the fourth embodiment.

### BEST MODE FOR CARRYING OUT THE INVENTION

In the following, embodiments of the present invention will be described with reference to the accompanying drawings.

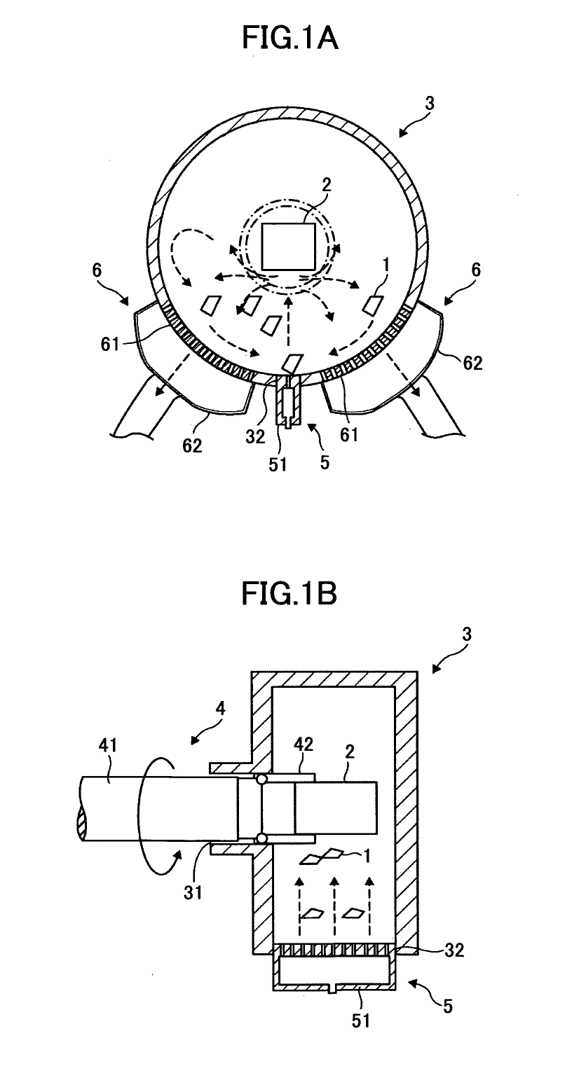

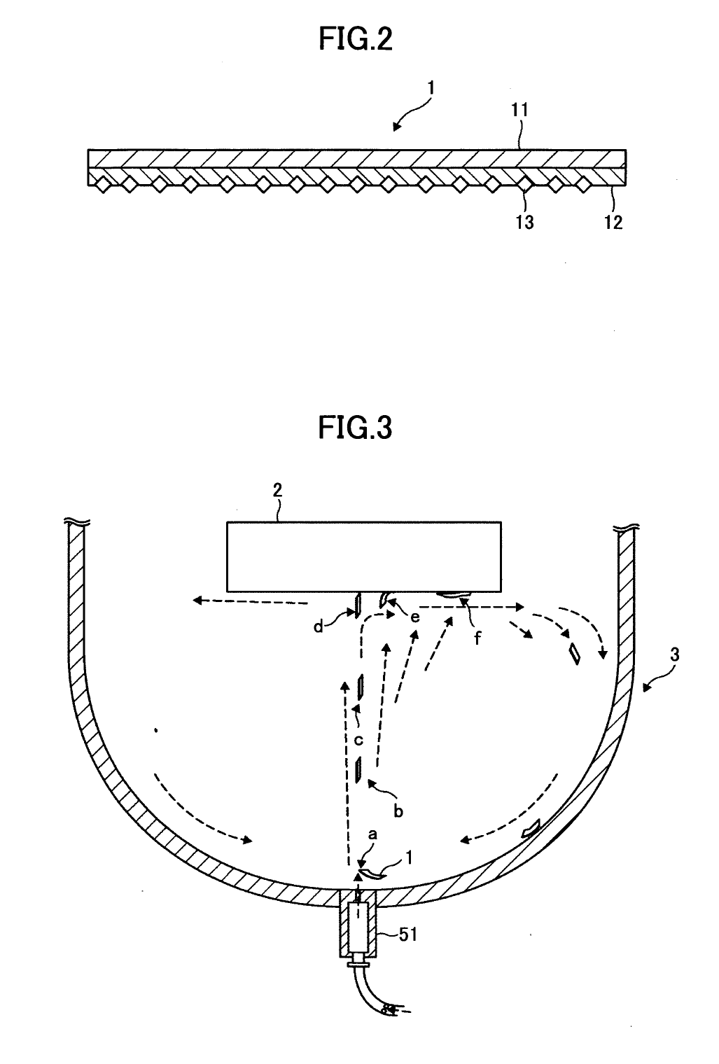

FIG. 1A is a front sectional view and FIG. 1B is a sectional side view illustrating a configuration of a cleaning apparatus according to a first embodiment. FIG. 2 is a sectional side view illustrating a configuration of a cleaning medium according to the first embodiment.

FIGS. 1A and 1B illustrate a cleaning medium 1, an object subject to cleaning 2 (hereinafter also referred to as a “cleaning target object 2”), a cleaning tank 3, a cleaning target object holding unit 4, a cleaning media movement acceleration unit 5 and an adherent substance collection unit 6. In FIGS. 1A and 1B, dashed arrows indicate directions of an airflow.

The cleaning tank 3 has a cylindrical structure and is arranged in a horizontal direction. The cleaning tank 3 has an internal space where the cleaning media 1 are allowed to scatter. The cleaning tank 3 includes an opening 31 at the center of its side surface to load/unload the cleaning target object 2 inside/outside the cleaning tank 3, and also includes an opening 32 at its lower end to introduce the airflow into the cleaning tank 3 via the cleaning media movement acceleration unit 5. The cleaning tank 3 also includes separation members 61 and suction ducts 62, one set at a lower left side and the other set at a lower right side of its peripheral surface, to collect the adherent substance previously adhering to the object.

The cleaning target object holding unit 4 includes a cylindrical arm 41 and holding member 42 provided at an end of the arm 41. The holding member 42 holds four sides of an end of the cleaning target object 2 to be loaded/unloaded inside/outside the cleaning tank 3 via its opening 31. When the cleaning target object 2 is loaded inside the cleaning tank 3, the cleaning target object 2 is placed at the center of the internal space of the cleaning tank 3. An outer diameter of the arm 41 corresponds to an inner diameter of the opening 31. Accordingly, when the cleaning target object 2 is held by the holding member 42 to be located at the center of the internal space of the cleaning tank 3, the opening 31 is closed with the arm 41, thereby preventing the cleaning media 1 and the airflow from leaking outside via the opening 31 of the cleaning tank 3. Further, the arm 41 is rotationally arranged inside the opening 31 such that the outer periphery of the arm 41 comes adjacent to the inner periphery of the opening 31. Accordingly, a location angle of the cleaning target object 2 maybe adjusted or modified by the rotation of arm 41 holding the cleaning target object 2.

The cleaning media movement acceleration unit 5 includes an acceleration nozzle 51, a compressor connected to the acceleration nozzle 51, and a not shown compressed air supply device having a control valve and an air line. The acceleration nozzle 51 includes plural upward blast ports in a line which are fitted in the opening 32 at a lower end of the cleaning tank 3. The compressed air supply device supplies the compressed air to the acceleration nozzle 51, and the acceleration nozzle 51 jets the compressed air into the cleaning tank 3 via its plural blast ports, thereby generating the airflow to move the cleaning media 1 inside the cleaning tank 3.

The adherent substance collection unit 6 includes the left and right separation members 61 and the left and right suction ducts 62 arranged outside the corresponding left and right separation members 61, and a not shown suction device having a blower (not shown) connected to the left and right suction ducts 62. The left and right separation members 61 are formed of porous members such as wire gauze, plastic gauze, mesh, perforated metal, and a slit plate such that the left and right separation members 61 pass gas, the adherent substances removed from the cleaning target object 2 including contamination formed of dust, powder, coating, or rust, and abraded powder produced by the abrasion of the adherent substances adhering to the cleaning target object; however, they do not to pass the cleaning media 1. Note that the relatively large sized cleaning media 1 for removing the adherent substances adhering to the cleaning target object 2 are configured not to pass through the separation members 61; however, those damaged or separated due to wear and tear are smaller in size so that they are allowed to pass through the separation members 61. One of the separation members Elis arranged at a lower left side and the other is arranged at the lower right side of the outer periphery of the cleaning tank 3.

The suction device suctions via the suction ducts 62 the air inside the cleaning tank 3, the scattering adherent substances removed from the cleaning target object 2, and the adherent substances detached the from the cleaning media 1 that are separated by the separation members 61. The cleaning media 1 made smaller due to cracking and damage accumulation are also separated by the separation members 61 to be suctioned by the suction device via the suction ducts 62. The airflow generated via the plural blast ports of the acceleration nozzle 51 moves toward the center of the cleaning tank 3 where the cleaning target object 2 is located and then is suctioned by the suction device. The airflow path is thus formed inside the cleaning tank 3.

In the following, embodiments of the cleaning medium will be described with reference to the accompanying drawings. FIG. 2 is a sectional side view illustrating a configuration of a cleaning medium according to the first embodiment. When the cleaning media 1 are used in the cleaning apparatus according to the first embodiment illustrated in FIGS. 1A and 1B, they are enclosed in the cleaning tank 3 and caused to move inside the cleaning tank 3 by the airflow jetted from the blast ports of the acceleration nozzle 51, thereby causing the cleaning media 1 to contact the cleaning target object 2. The cleaning target object 2 is cleaned by the contact with the cleaning media 1 in this manner. Note that the cleaning media 1 may be used in cleaning apparatuses other than the cleaning apparatus illustrated in FIGS. 1A and 1b.

As illustrated in FIG. 2, the cleaning media 1 are obtained by forming the binder layer 12 on one surface of a sheet substrate 11, embedding the abrasive grains 13 in the binder layer 12, and cutting the obtained product into flakes. The substrate 11 is made of a flexible material having shock resistance, examples of which includes ceramics, cloth, paper, and resin. As a material for the binder layer 12, resin adhesive maybe used. As a material for the abrasive grains 13, alumina abrasives may be used. An example of the cleaning medium 1 includes a thickness range of 0.05 to 0.2 mm, an area of 100 mm² or less, and a weight of 30 mg or less.

Note that the abrasive grains 13 may be provided in both surfaces of the substrate 11. The configuration and properties of the cleaning medium 1 may be suitably determined based on the configuration of the cleaning apparatus, the size and the structure of the cleaning target object 2, and properties of the adherent substances adhering to the cleaning target object 2. For example, the area of the cleaning medium 1 may be associated with the cleaning apparatus. If the areas of the cleaning media 1 are large, the cleaning media 1 may easily be accumulated (stay in the same positions) in the cleaning tank 3 of the cleaning apparatus. If the areas are, on the other hand, too small, it may be difficult to separate the cleaning media 1 from the adherent substances removed from the cleaning target object 2 or abraded powder detached from the cleaning target object 2 while they are all scattering inside the cleaning tank 3 of the cleaning apparatus. Accordingly, the cleaning media 1 need to have relatively large sizes in order to separate the cleaning media 1 from the adherent substances removed from the cleaning target object 2 or abrasive grains 13 detached from the cleaning media 1 while they are all scattering. Further, if the thickness of the cleaning medium 1 is 0.2 mm or more, the cleaning medium 1 may lose its flexibility. In this case, since the cleaning media 1 point contact the cleaning target object 2 when they collide with the cleaning target object 2, the cleaning speed may be lowered. If the thickness of the cleaning medium 1 is 0.05 mm or less, they may become attached to the cleaning target object 2, making it harder to remove the attached cleaning media 1 from the cleaning target object 2. If the abrasive grains 13 are provided in both sides of the cleaning medium 1, the abrading speed may be doubled but the cost may be increased. Accordingly, whether the abrasive grains 13 are provided in one side or both sides of the cleaning medium 1 maybe selected based on the cost and the performance.

Next, the scattering movements of the cleaning media are described. When a gas flow is applied to the cleaning media 1, the cleaning media 1 scatter with the gas flow. The orientation of the cleaning medium 1 when the gas flow is applied to the cleaning medium 1 may be various. For example, if the force of the gas flow acts on a large surface of the cleaning medium 1 in a scattering direction, that is, in the upward or downward direction perpendicular to the surfaces of the cleaning medium 1 in FIG. 2, the cleaning medium 1 may easily scatter with the gas flow at an accelerated speed, due to the cleaning medium 1 having an extremely low mass with respect to the velocity of the gas flow. In this case, since the cleaning medium 1 has a large gas flow resistance with its large surface (i.e., has a large gas flow resistance in a direction perpendicular to its large surface), the orientation of the cleaning medium 1 is changed, while scattering, in a direction parallel to its large surface as illustrated in FIG. 3, that is, the orientation of the cleaning medium 1 is changed into the rightward or leftward direction where the cleaning medium 1 has low gas flow resistance.

If the gas flow force acts on the small surface of the cleaning medium 1 from the beginning, the cleaning medium 1 may remain in the same orientation, while scattering, due to the low gas flow resistance with its small surface, or the cleaning medium 1 may first change its orientation and scatter with the gas flow due to the gas flow force acting on its large surface, and then change its orientation, while scattering, in a direction parallel to the large surface of the cleaning medium 1. The cleaning medium 1 is a flake and thus has a low gas flow resistance with its small surface. Accordingly, if the cleaning medium 1 scatters (is discharged) in a direction where the cleaning medium 1 has a low gas flow resistance, the cleaning medium 1 retains a high-speed scattering movement over a long distance. With such a movement of the cleaning medium 1, the cleaning medium 1 reaches the cleaning target object 2 to collide with the cleaning target object 2, thereby removing the adherent substances from the cleaning target object 2. Note that as described above, if the cleaning medium 1 scatters in the direction where the cleaning medium 1 has the small surface, that is, if the cleaning medium 1 scatters in its small surface direction and continuously scatters for a long distance, the energy that the cleaning medium 1 has may be increased, thereby efficiently carrying out the cleaning of the cleaning target object 2. The details of the removal of the adherent substances are described later.

Next, operations of the cleaning apparatus according to the first embodiment and associated movements of the cleaning media 1 according to the first embodiment are described. The cleaning media 1 supplied to the cleaning tank 3 of the cleaning apparatus are accumulated at the bottom of the cleaning tank 3. A user initially operates the holding member 42 of the cleaning target object holding unit 4 to tightly hold the cleaning target object 2 and locate the cleaning target object 2 inside the cleaning tank 3 via the opening 31. When the opening 31 is closed with the arm 41, the suction device (not shown) of the adherent substance collection unit 6 is operated to suction the air inside the cleaning tank 3, thereby generating a negative pressure inside the cleaning tank 3. Subsequently, the compressed air is jetted from the acceleration nozzle 51 in an upward vertical direction by operating the cleaning media movement acceleration unit 5.

The compressed air flows in a direction toward the cleaning target object 2 and collides with the cleaning target object 2, or collides with a ceiling of the cleaning tank 3 and moves toward an inner left side surface and an inner right side surface of the cleaning tank 3. The compressed air further flows downward along the inner surface of the cleaning tank 3 toward the bottom of the cleaning tank 3 together with the airflow suctioned by the suction device of the adherent substance collection unit 6. The airflow flowing from the acceleration nozzle 51 down to the bottom of the cleaning tank 3 is thus generated.

Referring to FIG. 3, the movements of the cleaning media 1 inside the cleaning tank 3 are described. In FIG. 3, dashed arrows indicate directions of the airflow. Note that the components that are not directly related to the description of the movements of the cleaning media 1 inside the cleaning tank 3 are omitted from FIG. 3.

The cleaning media 3 accumulated at the bottom of the cleaning tank 3 scatter with the airflow. That is, since the cleaning media 1 are accumulated at the bottom of the cleaning tank 3, the airflow is applied to the large area of the cleaning medium 1 in its scattering direction. Since the cleaning medium 1 has an exceedingly light weight of 30 mg or less, the cleaning medium 1 scatters in an upward direction toward the cleaning target object 2 at an accelerated speed (as indicated by an arrow “a” in FIG. 3). In the first embodiment, since the airflow is applied to the cleaning medium 1 at a flow rate of 20 m/s or more, the scattering rate of the cleaning medium 1 may be accelerated up to the flow rate of the airflow.

When the cleaning medium 1 flies (scatters) in a direction perpendicular to its large surface, the cleaning medium 1 has a high air resistance. Accordingly, the orientation of the cleaning medium 1 is changed into a direction parallel to its large surface (as indicated by an arrow “b” in FIG. 3), where the cleaning medium 1 has a low air resistance. The cleaning medium 1 maintaining this orientation scatters (flies) with the airflow, continuously moves toward the cleaning target object 2 at approximately the same rate as the airflow rate, and reaches the cleaning target object 2, thereby contacting the cleaning target object 2 (as indicated by arrows “c” and “d” in FIG. 3).

Accordingly, an edge of the cleaning medium 1 initially collides with the cleaning target object 2. In the first embodiment, a collision angle of the cleaning medium 1 is approximately in a range of 45 to 90 degrees, and the cleaning medium 1 collides with a surface (cleaning surface) of the cleaning target object 2 in the range of such collision angles.

The cleaning medium 1 has flexibility. The cleaning medium 1 after the edge of the cleaning medium 1 collides with the cleaning target object 2 is deflected and changes its orientation such that the collision surface of the cleaning medium 1 is located adjacent to the cleaning surface of the cleaning target object 2. Further, the cleaning medium 1 turns its moving direction to a direction along the cleaning surface toward an end of the cleaning target object 2 and slidably moves along the cleaning surface of the cleaning target object 2 (as indicated by arrows “e” and “f”). The adherent substances such as dust or powder adhering to the cleaning target object 2 are scrubbed or tapped by the collision with the cleaning medium 1 to thereby remove the adherent substances from the cleaning target object 2. When the cleaning medium 1 collides with the cleaning target object 2, the abrasive grains 13 around the edge of the cleaning medium 1 abrade the cleaning surface of the cleaning target object 2. The abrasive grains 13 in the surface of the cleaning medium 1 abrade the adherent substances from the cleaning surface of the cleaning target object 2 by the sliding movement of the cleaning medium 1 after its collision with the cleaning target object 2.

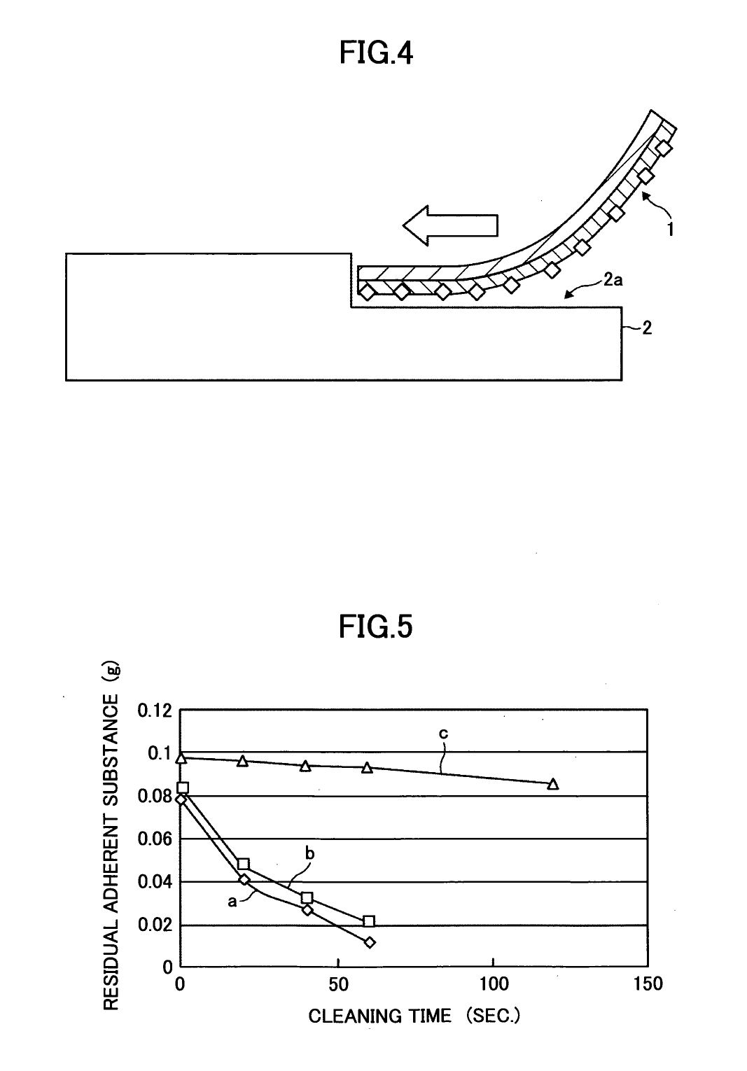

Further, since the cleaning medium 1 has flexibility, the cleaning medium 1 is capable of flexibly reaching uneven portions, recesses, and projections of the cleaning surface of the cleaning target object 2. Since the edge of the cleaning medium 1 is capable of reaching or contacting the deepest ends of the uneven portions, recessed or projected surfaces of the cleaning surface of the cleaning target object 2, the cleaning surface of the cleaning target object 2 is abraded with the abrasive grains 13 fixed to the edge of the cleaning medium 1. FIG. 4 illustrates the edge of the cleaning medium 1 that reaches an uneven portion 2a of the cleaning target object 2. In FIG. 4, the edge of the cleaning medium 1 slides into the deepest end of the uneven portion 2a after the cleaning medium 1 collides with the uneven portion 2a of the cleaning target object 2.

The sliding movement of the cleaning medium 1 along the cleaning surface of the cleaning target object 2 is carried out by the energy acquired by the cleaning medium 1 when colliding with the cleaning target object 2 and the airflow pressure generated after the collision with the cleaning target object 2. Accordingly, the cleaning medium 1 that has turned its orientation by colliding with the cleaning target object 2 is pushed by the airflow force, closely slides on the cleaning surface of the cleaning target object 2, and moves toward the end of the cleaning target object 2. In the above case, not only does the edge of the cleaning medium 1 abrades the uneven portions of the cleaning target object 2 but also the surface of the cleaning medium 1 abrades the large surface of the cleaning surface of the cleaning target object 2.

Further, the airflow is not always constant but varies. Meanwhile, since the cleaning medium 1 used is in a form of a flake, air resistance against the cleaning medium 1 largely varies with its orientation. Further, its orientation and movements are largely affected by the direction in which the airflow is applied. Accordingly, when the airflow changes its direction, the cleaning medium 1 not only changes its direction along the airflow direction but also exhibits complicated movements. The cleaning medium 1 specifically demonstrates such complicated movements near the cleaning target object 2. As a result, the cleaning medium 1 that has nearly moved away from the cleaning target object 2 moves back to the cleaning target object 2 to repeatedly collide with the cleaning target object 2, or the cleaning medium 1 moving along the airflow collides with the cleaning target object 2 at various angles other than at the angle to the small surface of the cleaning medium 1 in the scattering direction.

After colliding with the cleaning target object 2 to clean the surface of the cleaning target object 2 with sliding movements, the cleaning media 1 are blown off from the cleaning surface of the cleaning target object 2 by the airflow. Accordingly, the cleaning media 1 scatter radially and finally reach the inner surface of the cleaning tank 3. The cleaning media 1 that do not reach the cleaning target object 2 and move straight toward the ceiling of the cleaning tank 3 collide with the ceiling of the cleaning tank 3, move with the airflow inside the cleaning tank 3, and finally reach the inner surface of the cleaning tank 3.

The cleaning media 1 that have reached the inner surface of the cleaning tank 3 move above the separation members 61 to slidably fall near the acceleration nozzle 51 by interaction between the airflow and gravity. In this process, the cleaning media 1 scattering above the separation members 61 fall near the acceleration nozzle 51 while they are suctioned. Thus, when the cleaning media 1 pass above the separation members 61, the adherent substances and the abraded powder detached from the cleaning media 1 are suctioned and collected by the adherent substance collection unit 6. The adherent substances and the abraded powder detached from the cleaning target object 2 that are not attached to the cleaning media 1 and scatter themselves are also suctioned and collected with the adherent substances and abrasive grains separated from the cleaning media 1.

The cleaning media 1 that fall near the acceleration nozzle 51 are pushed again by the airflow jetted from the acceleration nozzle 51 such that the cleaning media 1 collide with the cleaning target object 2. Such cleaning operations are repeatedly carried out, thereby removing the adherent substances adhering to the surface of the cleaning target object 2.

While the cleaning target object 2 that is cleaned with the scattering cleaning media 1 is rotated by rotating the arm 41 of the cleaning target object holding unit 4, all the surfaces of the cleaning target object 2 are cleaned.

Note that if the adherent substances such as dust removed from the cleaning target object 2 have relatively low viscosity and thus are easily separated, the adherent substances may be collected by a positive pressure of the cleaning tank 2 without having to connect the suction device.

FIG. 5 is a graph illustrating a result of a cleaning experiment using the cleaning media 1 according to the first medium embodiment and the cleaning apparatus according to the first apparatus embodiment. In this experiment, the cleaning target object 2 was cleaned with cleaning media a, b, and c, and amounts of the residual adherent substances on the cleaning target object 2 were compared between the cleaning media a, b, and c used for removing the adherent substances adhering to the cleaning target object 2. FIG. 5 illustrates a relationship between the cleaning time and the weight of the residual adherent substances on the cleaning target object 2. The cleaning medium a is sand paper including abrasive grains (grain size #300) manufactured by SIA Corporation, the cleaning medium b is an abrasive tape having abrasive grain size of #1000 manufactured by Comback Corporation, and the cleaning medium c is an abrasive tape having abrasive grain size of #4000 manufactured by 3M Corporation. Note that the grain sizes of the abrasive grain comply with JIS R6001 standards.

In this experiment, flux was applied in a film form to a glass epoxy board in a square area of 50*50 mm that was used as the residual adherent substances adhering to the cleaning target object 2. The hardness of flux was the pencil hardness of “B”. The flux adhering method includes applying flux to the glass epoxy board, drying the flux-applied glass epoxy board, and heating the dried flux-applied glass epoxy board at 250° C., thereby obtaining the flux adherent glass epoxy board. Note that the flux was selected because it has an appropriate hardness to obtain the easily identifiable abrasive results. Note also that the pencil hardness complies with JIS K5600 5-4.

The compressed air of 0.35 MPa was supplied to the acceleration nozzle 51 to generate the airflow, and the generated airflow caused the cleaning media 1 to scatter inside the cleaning tank 3 to collide with the cleaning target object 2. As cleaning media 1, 5 mm square pieces cut out of the above-described abrasive sheet or the abrasive tape were prepared. The space density of the cleaning media 1 inside the cleaning tank 3 was determined as 3000 pieces/liter. The space density of the cleaning media 1 inside the cleaning tank 3 was determined as above, because the appropriate space density of the cleaning media 1 of the above size was in a range of 2000 to 5000 pieces/liter. If the space density is less than this range, there may only be a small number of cleaning media 1 that can collide with the cleaning target object 2 inside the cleaning tank 3, resulting in an inefficient cleaning performance. If the space density is, on the other hand, greater than this range, not all the cleaning media 1 may scatter but some remain unscattered (stay in the same positions), resulting also in an inefficient cleaning performance. A cleaning apparatus used in this experiment had a capacity of approximately 2 liters. In this experiment, when the space density of the cleaning media 1 was 5000 pieces/liter or more, some cleaning media 1 remaining unscattered was observed with naked eye, whereas when the space density of the cleaning media 1 was 2000 pieces/liter or less, the number of collisions with the cleaning target object 2 was drastically decreased. Note that the above values obtained may be unique to the cleaning apparatus used in the experiment and may vary with conditions such as the size of the cleaning apparatus, arrangement of the nozzle, and the flow rate of the airflow.

As illustrated in FIG. 5, the results showed that a longer cleaning time was required for removing the flux (i.e., residual adherent substances) with the cleaning media 1 having the abrasive grain size of #4000 (indicated by “c”). However, approximately 80% of the residual adherent substances were removed in 60 s. with cleaning media 1 having the abrasive grain size of #1000 or less (indicated by “b”).

Repeated use of the cleaning media 1 result in physical deterioration. In particular, parts of the cleaning media 1 are damaged and separated (broken off) by repeatedly colliding with the cleaning target object 2. Some types of the separation (breakage) may lower the cleaning performance of the cleaning media 1.

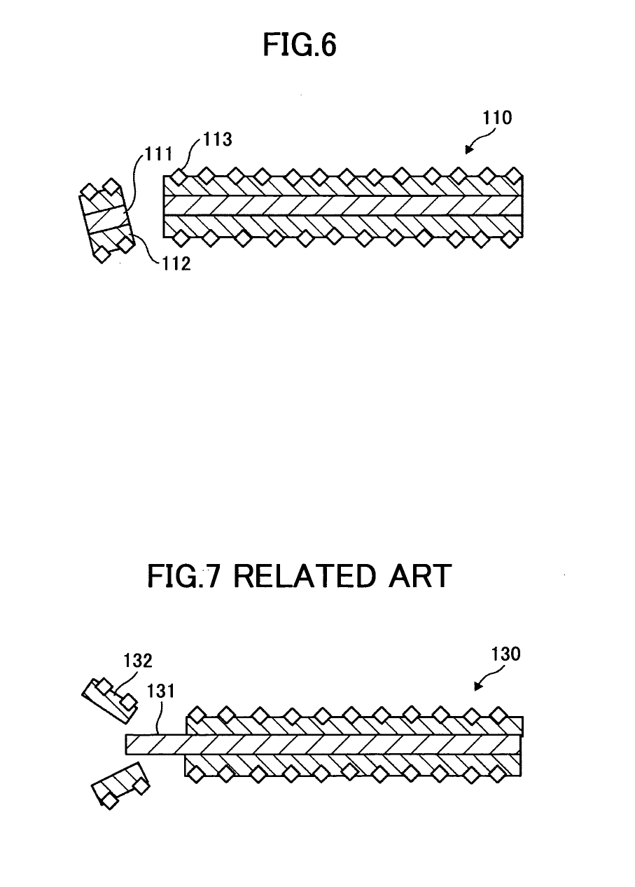

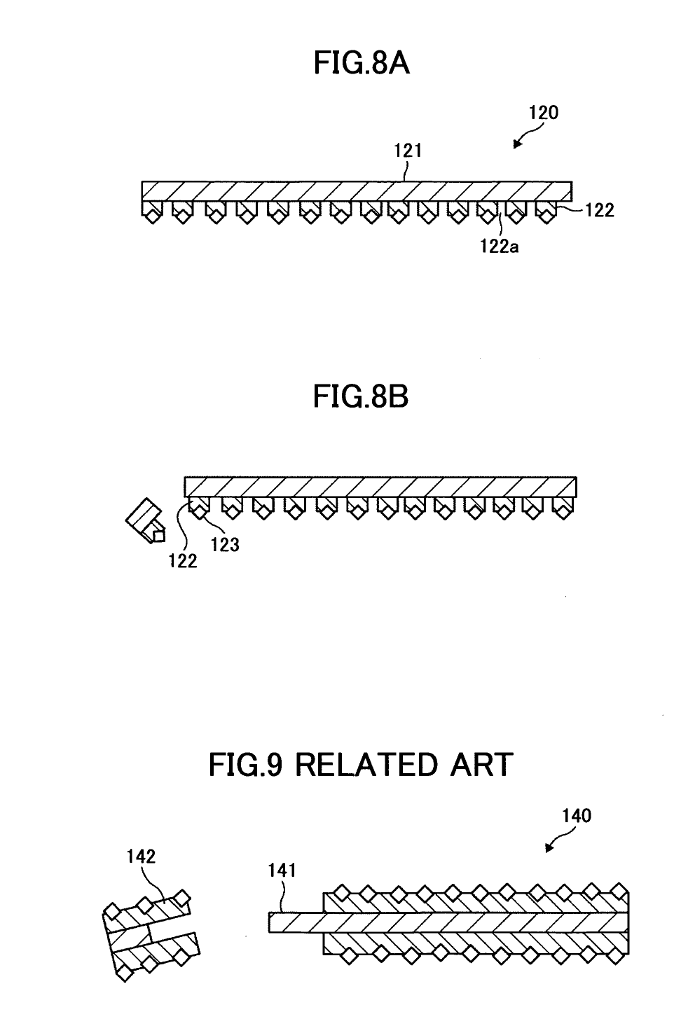

FIG. 6 and FIGS. 8A and 8B respectively illustrate cleaning media 110 and 120 according to second and third medium embodiments that are capable of preventing the lowering of the cleaning performance of the cleaning media 110 and 120 due to such breakage separation. The cleaning media 110 and 120 respectively illustrated in FIG. 6 and FIGS. 8A and 8B have brittleness.

As illustrated in FIG. 6, the cleaning medium 110 includes a substrate 111 made of a brittle material, and a binder layer 112 made of a material having the pencil hardness higher than the substrate 111. In the second embodiment, polyimide or triacetyl cellulose may be used as a material for the substrate 111. Polyimide or triacetyl cellulose used is a polyimide film or a triacetyl cellulose film having a thickness of 0.2 mm or less and having folding endurance (durability) of 65 times or less. If the folding endurance is low, a brittle fracture may occur before deformation by external force.

As a material for the binder layer 112, resin adhesive may be used. Note that the “brittleness” indicates a “property in which an object is broken or fractured before the object exhibits plastic deformation or immediately after the objects slightly exhibits plastic deformation”. The pencil hardness of the binder layer 112 used is “4H”, whereas the pencil hardness of the substrate 111 used is “H”. Note that the above pencil hardnesses are in compliance with JIS K5600 5-4, and the folding endurance is in compliance with JIS P8115.

As illustrated in FIG. 6, an end portion of the cleaning medium 110 is damaged and broken off. In this case, the end portion of the cleaning medium 110 has the substrate 111 and the binder layer 112 broken off at the same position of the cleaning medium 110. After the end portion is broken off, a new edge having abrasive grains 113 of the cleaning medium 110 appears. If the cleaning medium 110 according to the second embodiment having the above properties is used, the lowering of the abrasive performance of the cleaning medium 110 may be reduced, and the abrasive performance may be maintained for a longer period of time.

If, on the other hand, the substrate is not made of the brittle material and has durability (i.e., folding endurance), or the binder layer 112 has the pencil hardness lower than the substrate 111, the bonding power of the binder layer 112 is weak. Therefore, part of the binder layer 132 may come off the cleaning medium 130 by itself due to the collision impact, and leave only the substrate 131 in the end portion of the cleaning medium 130 as illustrated in the related art example of FIG. 7. As a result, the abrasive performance of the edge of the cleaning medium 130 may be lowered.

FIGS. 8A and 8B illustrate a cleaning medium 120 according to the third embodiment that has a substrate 121 made of the brittle material and a binder layer 122 having cutout portions 122a.

FIG. 9 illustrates another related art example of a cleaning medium 140 having a film-like binder layer 142 continuously formed on a substrate 141, where the bonding power of the binder layer 142 to the substrate 141 is lower than cohesive power of the binder layer 142. In this case, when the brittle fracture occurs in the substrate 141, amounts of the binder layer 142 beyond the broken position of the substrate 141 may be removed due to the strong cohesive power of the binder layer 142 as illustrated in FIG. 9. As a result, a newly appearing end portion of the cleaning medium 140 has only the substrate 141. Thus, the cleaning capability of the cleaning medium 140 may be lowered, thereby lowering the cleaning performance. In order to prevent such an adverse effect, the bonding power of the binder layer 142 to the substrate 141 is increased such that the bonding power of the binder layer 142 to the substrate 141 is stronger than the cohesive power of the binder layer 142. With this configuration, similar to the example of FIG. 6, the end portions of the substrate 141 and the binder layer 142 are integrated, and the end portions of the substrate 141 and the binder layer 14 may thus be broken off at the same positions of the cleaning medium 140.

Further, the cleaning medium 120 having the binder layer 122 with the cutout portions 122a illustrated in FIGS. 8A and 8B may prevent the following adverse effects. The cutout portions 122a are provided in the binder layer 122 such that a portion of the binder layer 122 together with the corresponding cutout portion 122a is broken off easily at a position where the cleaning medium 120 is damaged and broken off. That is, the binder layer 122 provided on the substrate 121 is configured to have low-durability portions (having low folding endurance) at predetermined positions (or predetermined intervals). Alternatively, other methods such as reducing the thickness of the cutout portions 122a, or forming no binder layer 122 on the substrate 121 corresponding to the cutout portions 122a may be used for providing the binder layer 122 having the low-durability portions at predetermined positions.

In FIG. 8A, the binder layer 122 is discontinuously formed on the substrate 121 by arbitrarily applying the binder layer 122. In such a configuration, the cutout portions 122a of the substrate 121 where no binder layer 122 is applied are susceptible to the brittle fracture. Accordingly, after an end portion of the cleaning medium 120 is broken off, a newly appearing edge portion of the cleaning medium 120 includes the binder layer 122 and abrasive grains 123 to be able to maintain the abrasive performance as illustrated in FIG. 8B. The pitch of the cutout portions 122a is configured to be smaller than discharge pores provided in the separation members 61 of the cleaning tank 3. With this pitch size, the broken off portion of the cleaning medium 120 may be rapidly discharged outside of the cleaning tank 3 after separating from the cleaning medium 120. In the third embodiment, numerous discharge pores having a diameter of 1 mm are provided in the separation members 61, and the cutout portions 122a are provided in the binder layer 122 at a pitch less than 1 mm, more preferably 0.2 mm or less, in view of the diameter of the discharge pores and the pitch for facilitating the discharge of the broken-off portions of the cleaning media 120. Note that uneven portions (recesses and projections) are formed on the surface of the binder layer 122 by discontinuously applying the binder layer 122 or applying a thinner binder layer 122, so that the airflow around the cleaning media 120 progressively circulates. Accordingly, the broken-off portions of the cleaning media 120 maybe prevented from being retained on the surfaces of the cleaning target object 2, the surfaces of the cleaning media 120, or the inner surfaces of the separation members 61 of the cleaning tank 3.

Next, a cleaning medium 150 according to a fourth medium embodiment is described. In order to abrade the cleaning surface of the cleaning target object 2, the cleaning medium 150 needs to slide on the cleaning surface of the cleaning target object 2 with its surface having the abrasive grains. In the fourth embodiment, the cleaning medium 150 is configured to slide on the surface of the cleaning target object 2 when the cleaning medium 150 is pushed by the airflow, or when the cleaning medium 150 is restored after being compressed by the airflow.

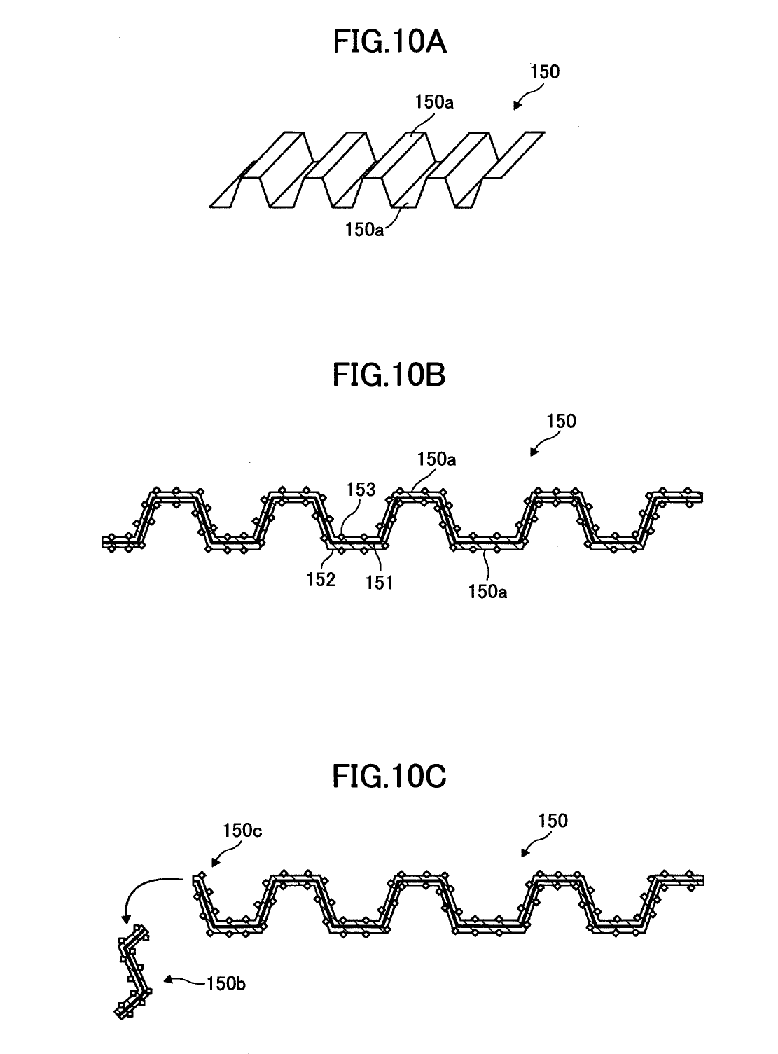

FIG. 10A is a perspective view of the cleaning medium 150 according to the fourth medium embodiment; FIG. 10B is its side view. The cleaning medium 150 according to the fourth medium embodiment includes a substrate 151, binder layers 152 provided on both surfaces of the substrate 151, and the abrasive grains 153 provided in the surfaces of the binder layers 152. The cleaning medium 150 is folded in a trapezoidal wave structure having flat portions 150a at folded portions such that the cleaning medium 150 has an accordion-like structure having a restoring force to stretch and contract. The cleaning medium 150 having the accordion-like structure is capable of stretching and contracting in a surface direction and has elasticity to stretch or contract in an applied force direction and be restored when the applied force is cancelled.

A material for the cleaning medium 150 according to the fourth medium embodiment may be the same as any of those used in the first and second embodiments; however, a resin film having high ductility or paper having high toughness may be preferably used as the material for the cleaning medium 150 that is capable of stretching, contracting, and restoring in a flat surface direction.

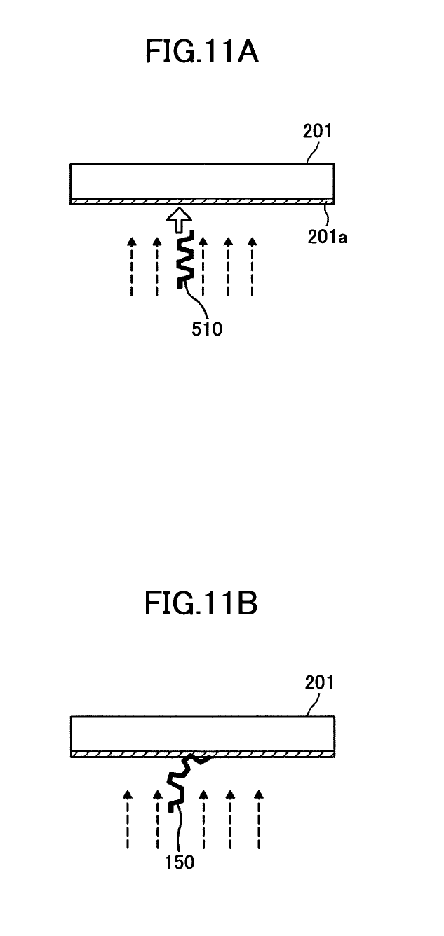

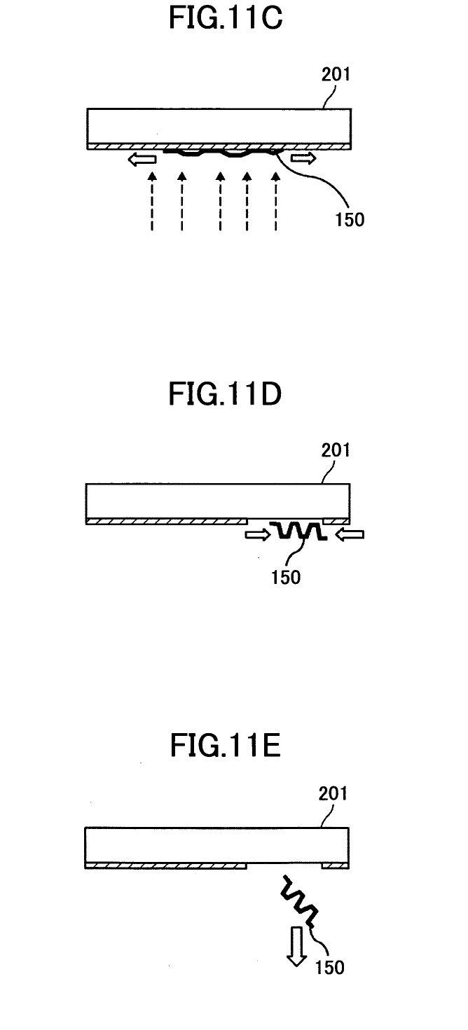

Next, behaviors of the cleaning media 150 according to the fourth medium embodiment are described. FIGS. 11A through 11E illustrate steps from causing the cleaning medium 150 to collide with a cleaning target object 201 by the application of the airflow (indicated by dashed arrows) and to separate the cleaning medium 150 from the cleaning target object 201. In FIGS. 11A through 11E, an adherent substance 201a adheres to the cleaning target object 201.

The behaviors of the cleaning media 150 are described below. As illustrated in FIG. 11A, the cleaning medium 150 is discharged (scatters) toward the cleaning target object 201 by receiving a high-speed airflow.

Subsequently, as illustrated in FIG. 11B, an edge portion of the cleaning medium 150 collides with a cleaning surface of the cleaning target object 201. Since the cleaning medium 150 has elasticity in its surface direction, the edge portion of the cleaning medium 150 is deformed along the cleaning surface direction of the cleaning target object 201. When the cleaning medium 150 in the above state is further pushed from its back side, the cleaning medium 150 changes its direction to a direction parallel to the cleaning surface direction of the cleaning target object 201, and the cleaning medium 150 having the accordion-like structure then stretches out along the cleaning surface of the cleaning target object 201 by receiving the airflow on the surface of the cleaning medium 150. The stretching movement of the cleaning medium 150 carries out the sliding movement along the cleaning surface of the cleaning target object 201, where the abrasive grains 153 fixed in the surface of the cleaning medium 150 slidably contact the cleaning surface of the cleaning target object 201 to abrade the cleaning surface of the cleaning target object 201.

Further, when time has further elapsed, the cleaning medium 150 slidably moves to an area where the airflow compression force is weak as illustrated in FIG. 11D. When the airflow compression force is weak, the cleaning medium 150 having the restoring force restores its accordion-like structure. In this process, the cleaning medium 150 still carries out the abrasion process. Since the airflow easily enters between the cleaning medium 150 restoring the trapezoidal wave structure and the cleaning target object 201, the cleaning medium 150 falls off the cleaning target object 201 as illustrated in FIG. 11E.

Note that the restoring force of the cleaning medium 150 having the accordion-like structure operates in its sliding direction. Accordingly, even if the friction coefficient of the cleaning surface of the cleaning target object 201 is relatively high, the cleaning medium 150 can still abrade the cleaning target object 201 by its sliding movements. Note also that since the restored cleaning medium 150 is easily separated from the cleaning target object 201 by the airflow, the cleaning medium 150 may not remain at the same position and be circulated despite the fact that the cleaning target object 201 itself or the adherent substance 201a adhering to the cleaning target object 201 has viscosity. Accordingly the cleaning medium 150 may be repeatedly used.

The characteristic value indicating the toughness of the cleaning medium 150 may preferably be the Clark degree of 110 cm³/100 or more. In this case, even if the cleaning medium 150 is pushed against the cleaning target object 201 by the airflow, the cleaning medium 150 may still maintain its form to carry out the above-described movements. Moreover, if the Clark degree is 230 cm³/100 or less, the cleaning medium 150 may easily be deformed along the cleaning surface of the cleaning target object 201 after the collision, thereby obtaining an abrading effect on the cleaning target object 201 having the uneven surface. Note that the Clark degree complies with JIS-P 8143.

Next, the deterioration of the cleaning medium 150 is described below referring back to FIG. 10C. The edge portion of the cleaning medium 150 frequently collides with the cleaning target object 201 by strong force, so that the abrasive grains 153 are gradually detached from the binder layer 152 of the cleaning medium 150. Thus, the abrasive performance may be lowered. Meanwhile, the folded portion near an edge portion 150b may have fatigue fracture and finally break off due to the repeated collision of the edge portion of the cleaning medium 150 with the cleaning target object 201. A newly appearing edge portion 150c after the edge portion 150b is broken off the cleaning medium 150 has the abrasive performance higher than that of the edge portion 150b, because the number of collisions with the cleaning target object 201 is greater in the edge portion 150b than in the edge portion 150c due to the edge portion 150b having an outward surface and the edge portion 150c having an inward surface. Accordingly, the abrasive performance of the cleaning medium 150 may be maintained for a long period of time. The broken-off edge portion 150b together with abraded powder are discharged outside of the cleaning tank 3 via the separation members 61. Thus, extraneous substances including such broken off edge portions 150b and abraded powder may no longer remain inside the cleaning tank 3.

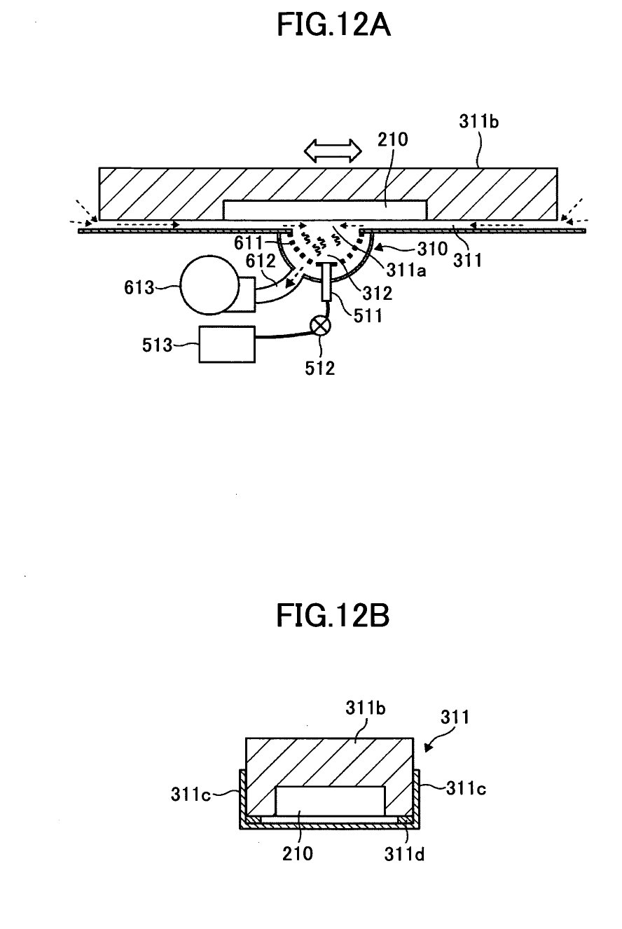

FIG. 12A is a front sectional view and FIG. 1B is a sectional side view illustrating a configuration of a cleaning apparatus 310 according to a second apparatus embodiment using the above cleaning medium 150. Note that the cleaning apparatus according to the second embodiment may use cleaning media other than the cleaning medium 150. As illustrated in FIGS. 12A and 12B, the cleaning apparatus 310 includes a holding unit 311 configured to hold the cleaning target object 210, and a cleaning unit 312 configured to clean the cleaning target object 210 by moving the cleaning medium 150. The holding unit 311 is a box-structured unit having no top surface. The holding unit 311 includes a rectangular opening 311a in the center across a bottom surface of the holding unit 311 in a short side direction. A cleaning unit 312 having a semicircular cylindrical space with an open top surface is provided beneath the rectangular opening 311a of the holding unit 311.

The holding unit 311 further includes a holding member 311b configured to hold the cleaning target object 210 in the center of its bottom surface. The holding member 311b has a rectangular structure and holds the cleaning target object 210 embedded in the center of its bottom surface. The cleaning target object 210 is located such that the cleaning surface of the cleaning target object 210 is downwardly directed to face the cleaning unit 312, and the cleaning surface of the cleaning target object 210 is located at the same level (height) as the bottom surface of the holding member 311b. The upper opening of the cleaning unit 312 is covered with the bottom surface of the holding member 311b.

The holding member 311b is sandwiched between the side guides 311c of the holding unit 311, such that the holding member 311b holds the cleaning target object 210 to reciprocate in a longitudinal direction of the holding unit 311 indicated by an right-left double arrow in FIG. 12A. Accordingly, the airflow may be applied to the entire cleaning surface of the cleaning target object 210 by the reciprocating movements of the cleaning target object 210 held by the holding member 311b. Further, the holding member 311b is placed on spacers 311d provided on the bottom surface of the holding unit 311 so that the holding member 311b has a small gap with an outer edge of the holding unit 311. With this configuration, the holding member 311b may acquire excellent movement. Further, when the cleaning unit 312 is suctioned, the airflow flows from outside the cleaning tank 310 into the gap in order to prevent the leakage of the cleaning medium 150 or the abraded powder from the cleaning tank 310.

Note that the cleaning medium 150 having the trapezoidal wave structure illustrated in FIGS. 10A to 10C used in the cleaning apparatus in the second embodiment has a three-dimensional structure and thus has a width in a vertical direction. Accordingly, the cleaning medium 150 is susceptible to the airflow and is less likely to be leaked from the cleaning tank 310 than the above-described cleaning medium 1 having the flake structure.

A semicircular separation member 611 having a structure similar to that of the cleaning unit 312 is provided along the inner surface of the cleaning unit 312. Similar to the separation members 61 illustrated in FIG. 1A, the separation member 611 is formed of perforated metal having numerous discharge pores for not allowing the cleaning medium 150 to pass through but allowing the abraded powder to pass through while suctioning.

The cleaning unit 312 includes the acceleration nozzle 511 arranged at its lowermost end. The acceleration nozzle 511 has plural blast ports aligned in a line for jetting the airflow toward the upper opening of the cleaning unit 312 and thus has the same configuration as the acceleration nozzle 51 illustrated in FIG. 1. The plural blast ports are arranged along a generatrix of the lowermost end of the separation member 611 provided along the inner surface of the cleaning unit 312. The acceleration nozzle 511 is connected with a control valve 512 and a compressor 513.

An outer periphery of the cleaning unit 312 includes a suction duct 612 connected to a suction device 613 that suctions and discharges the abraded powder detached from the cleaning target object 210 via the separation member 511.

The cleaning unit 312 of the cleaning apparatus according to the second embodiment causes the cleaning medium 150 having the trapezoidal wave structure illustrated in FIGS. 10A to 10C to scatter and collide with the cleaning target object 210. The cleaning medium 150 abrades the cleaning surface of the cleaning target object 210 and is detached (moved away) from the cleaning target object 210 while exhibiting the behaviors illustrated in FIGS. 11A to 11E. The cleaning medium 150 detached from the cleaning target object 210 slides along the inner surface of the separation member 611 provided inside the cleaning unit 312 to fall to a lower end of the separation member 611. In this process, the abraded powder or the like adhering to the surface of the cleaning medium 150 is detached from the leaning medium 150 by suctioning such that the capability of the cleaning medium 150 is restored. The adherent substances and the abraded powder detached from the cleaning target object 210 that are not attached to the cleaning media 150 and scatter themselves are also suctioned and discharged from the cleaning unit 312.

Note that since the cleaning medium 150 used in the cleaning apparatus according to the second embodiment has the three-dimensional trapezoidal wave structure, the airflow flowing in a direction perpendicular to the surface of the cleaning medium 150 may pass through the end portions of the surface of the cleaning medium 150 to reach the other side of the end portions of the surface of the cleaning medium 150. Accordingly, the airflow has excellent airflow movement against the cleaning medium 150, which may prevent the cleaning media 150 clogging the discharge pores of the separation member 611.

The cleaning media 150 having reached the lower end of the separation member 611 are scattered again by the airflow jetted by the acceleration nozzle 511, repeat the similar behaviors to clean the cleaning target object 210. While cleaning the cleaning target object 210, the holding member 311b that holds the cleaning target object 210 reciprocates in the longitudinal direction of the holding unit 311. Accordingly, the entire surface of the cleaning target object 210 is cleaned by the airflow applied from the cleaning unit 312. As described above, since the cleaning media 150 are circulated without remaining at the same positions in the cleaning unit 312, the adherent substance adhering to the cleaning target object 210 is efficiently abraded off.

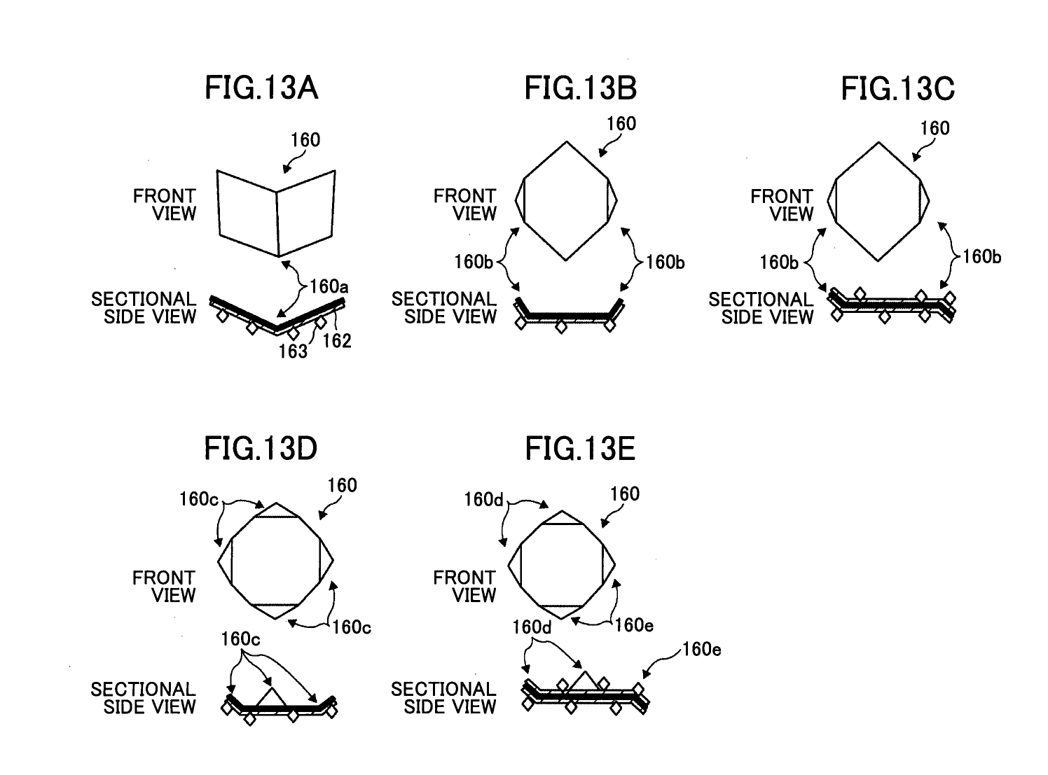

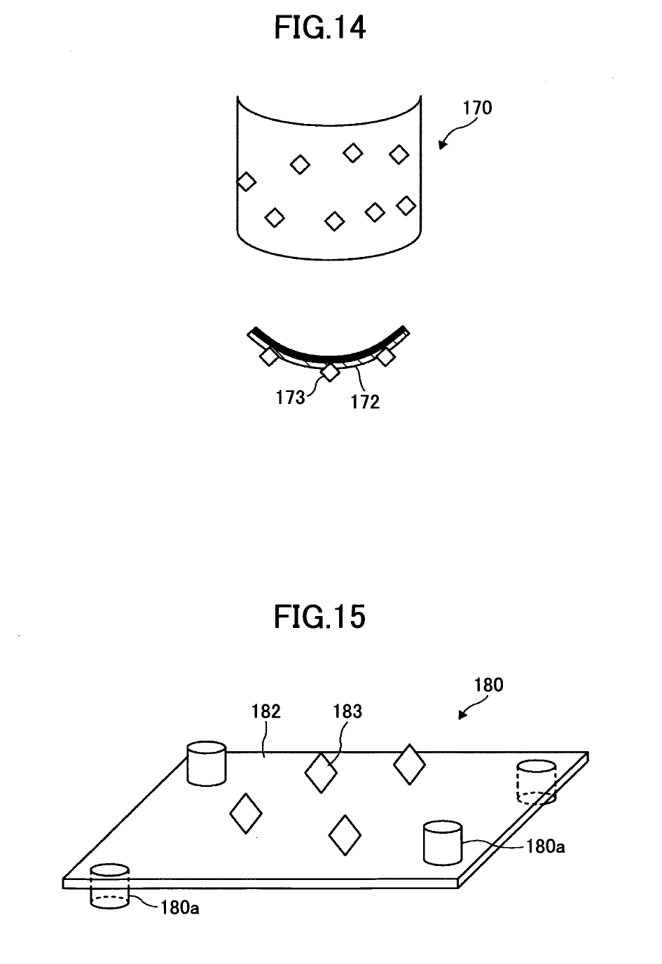

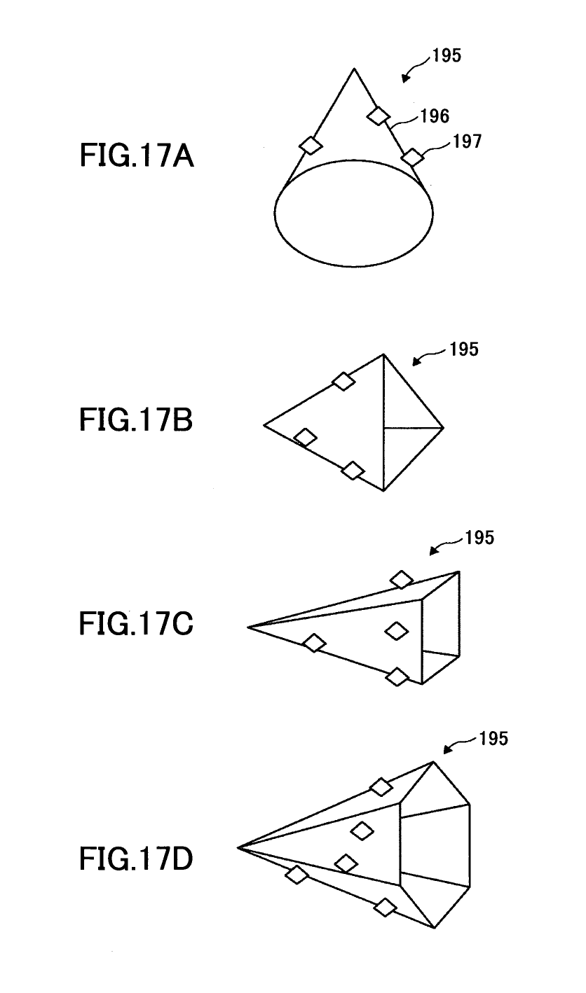

Next, cleaning media according to fifth to ninth medium embodiments having three-dimensional structures are described with reference to FIGS. 13A through 17D. Note that FIGS. 13A to 13E and FIG. 14 include front views and sectional side views of the corresponding cleaning media, and FIG. 15 and FIGS. 17A to 17D include perspective views of the corresponding cleaning media.

FIGS. 13A through 13E illustrate a cleaning medium 160 according to the fifth embodiment. The cleaning medium 160 according to the fifth embodiment includes a binder layer 162 and abrasive grains 163 fixed in the binder layer 162, and is folded in a three-dimensional structure. FIG. 13A is an example of the cleaning medium 160 according to the fifth embodiment having the three-dimensional structure obtained by folding a central portion 160a of the cleaning medium 160, FIG. 13B is another example having the three-dimensional structure obtained by folding two end portions 160b of two mutually facing corners of the cleaning medium 160 in upward directions, FIG. 13C is a modified example of FIG. 13B where one of the two end portions 160b is folded in an upward direction, and the other is folded in a downward direction, FIG. 13D is a modified example of FIG. 13B where four end portions 160c are folded in upward directions, and FIG. 13D is a modified example of FIG. 13B where two of the four end portions 160c are folded in upward directions, and the other two are folded in downward directions. Note that in the cleaning media illustrated FIG. 13C and 13E, the abrasive grains 163 are fixed in both sides of the cleaning medium 160.

FIG. 14 illustrates a cleaning medium 170 according to the sixth embodiment. The cleaning medium 170 according to the sixth embodiment includes a binder layer 172 and abrasive grains 173 fixed in the binder layer 172, and has a circular arc structure obtained by curving the cleaning medium 170.

FIG. 15 illustrates a cleaning medium 180 according to the seventh embodiment. The cleaning medium 180 according to the seventh embodiment includes a binder layer 182 and abrasive grains 183 fixed in the binder layer 182, and has projections 180a formed of burrs obtained by punching holes in the surface of the cleaning medium 180.

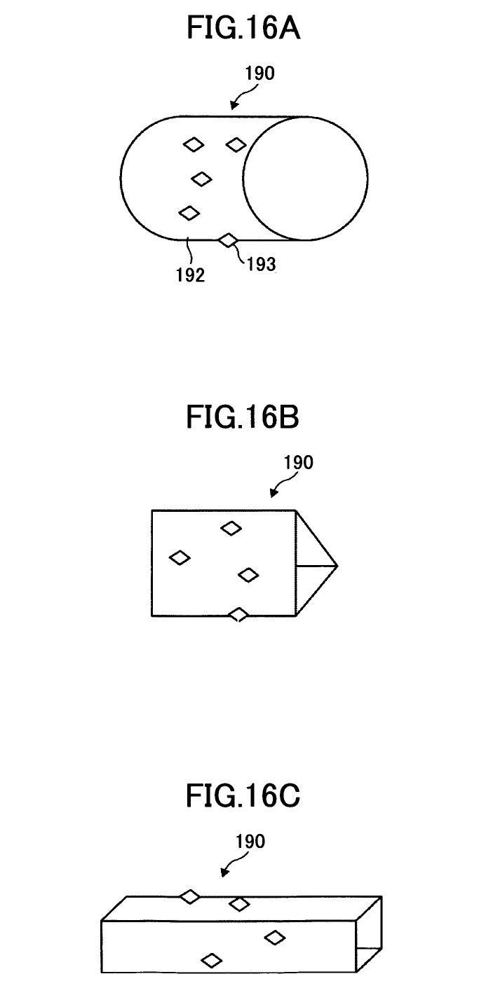

FIGS. 16A to 16C illustrate cleaning media 190 according to the eighth embodiment. The cleaning media 190 according to the eighth embodiment each include a binder layer 192 and abrasive grains 193 fixed in the binder layer 192, and has a tube structure of various types; that is, FIG. 16A is a, cylindrical structured example, FIG. 16B is a triangular tube structured example, and FIG. 16C is a square tube structured example.

FIGS. 17A to 17D illustrate cleaning media 195 according to the ninth embodiment. The cleaning media 195 according to the ninth embodiment each include a binder layer 196 and abrasive grains 197 fixed in the binder layer 196, and has a pyramidal structure, where FIG. 17A is a cone structured example, FIG. 17B is a triangular pyramid structured example, FIG. 17C is a quadrangular pyramid structured example, and FIG. 17D is a pentagonal pyramid structured example. Note that in FIGS. 16A to 16C and FIGS. 17A to 17D, the binder layers 192 and 196 in which the abrasive grains 193 and 197 are respectively provided are formed on corresponding outer surfaces of the cleaning media 190 and 195.

Note also that in FIGS. 13A through 17D, the abrasive grains are partially illustrated to simplify the drawings for easy comprehension.

The cleaning media according to the fifth to the ninth embodiments all have flake structures with characteristics of light weight, easy to scatter, and a partial three-dimensional structure or a complete three-dimensional structure. With this configuration, the cleaning media may be less likely to remain in the same positions due to the airflow effect. Further, the cleaning media having such configurations each have a collision surface smaller that the cleaning medium having a flat configuration against the cleaning target object. Accordingly, the cleaning media having such configurations apply increased abrading pressure to remove the adherent substances strongly adhering to the cleaning target object.

The above-described cleaning media according to the first to ninth embodiments having the different configurations may be used simultaneously. If the structure of the cleaning medium differs, its movements change accordingly. Thus, the adherent substances that are not removed by the cleaning medium of one embodiment may be removed by the cleaning media of other embodiments, thereby improving the cleaning effects.

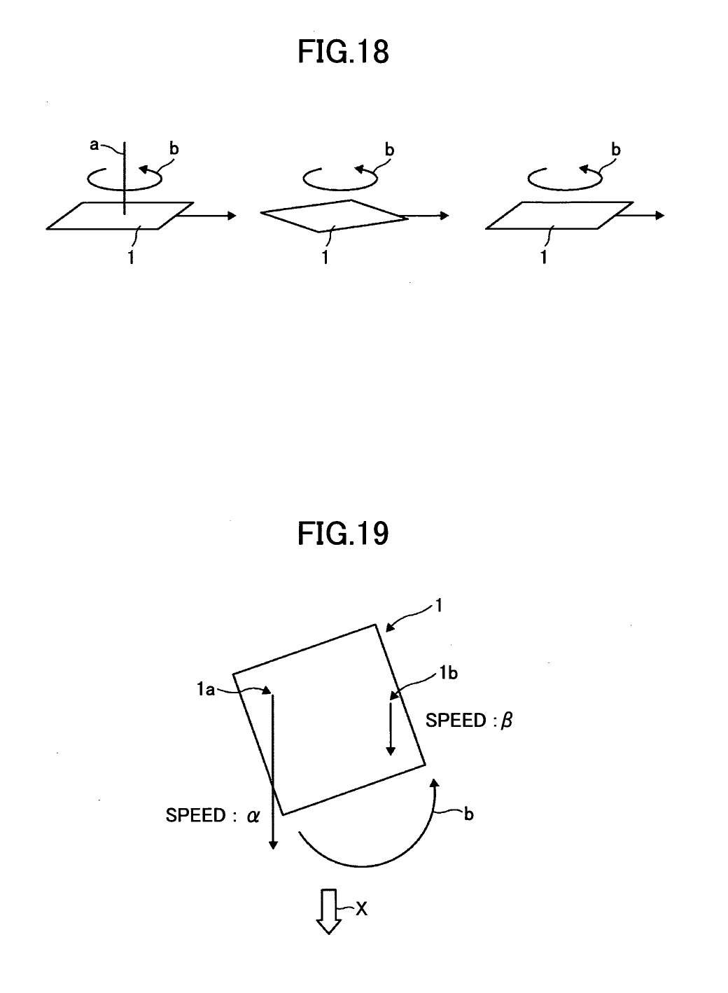

Next, a cleaning apparatus according to a third apparatus embodiment is described. In the cleaning apparatus according to the third embodiment, a turning force is applied to the cleaning medium 1 in a direction parallel to its surface to cause the cleaning medium 1 to scatter. FIG. 18 is a diagram illustrating the scattering direction of the cleaning medium 1 when the turning force is applied to the cleaning medium 1 in its surface direction. In the third embodiment, the cleaning medium 1 having a flake structure illustrated in FIG. 2 is employed as an example; however, any cleaning media described above may be used in the cleaning apparatus according to the third embodiment.

As illustrated in FIG. 18, if the cleaning medium 1 is caused to scatter by rotating it around an axis “a” perpendicular to the surface of the cleaning medium 1 in a direction indicated by an arrow “b”, an orientation of the cleaning medium 1 is stabilized by a rotational inertia of the rotating cleaning medium 1. Further, the cleaning medium 1 scatters with less air resistance, so that the speed of the scattering of the cleaning medium 1 is not so much decreased. Accordingly, the cleaning medium 1 may fly for a long distance. In addition, with the above effect (of long distance travel), if the abrasive grains are fixed in the surface of the cleaning medium 1, the cleaning medium 1 has an increased sliding speed and increased sliding distance by colliding with the cleaning target object while rotating, thereby providing a greater abrading effect on the cleaning surface of the cleaning target object.

FIG. 19 is a top view illustrating the cleaning medium 1 when the cleaning medium 1 is rotationally discharged.

In order to rotationally discharge the cleaning medium 1, a force is applied to the two different points 1a and 1b of its surface in the same directions but at different speeds α (high speed) and β (low speed). The two different points 1a and 1b are located such that the two points 1a and 1b face each other with respect to the center of the cleaning medium 1 sandwiched between the two points 1a and 1b. The applied speeds α and β may theoretically be any speeds insofar as there is a difference between the two speeds α and β. That is, the speed α may be zero or may be applied in a reverse direction of the speed α. Specifically, the force may theoretically be applied to the point 1b in a direction opposite to a direction X indicated by a thick arrow in FIG. 19. However, in practice, it is preferable to apply the force to the two points 1a and 1b in the same directions, because the cleaning medium 1 needs to be pushed out. In this manner, the force applied to the cleaning medium 1 differ in the two different points 1a and 1b facing each other with respect to the center of the cleaning medium 1 sandwiched between the two points 1a and 1b, so that the cleaning medium 1 is rotated in the direction indicated by the arrow “b” and translationally discharged in the direction of X indicated by the thick arrow in FIG. 19.

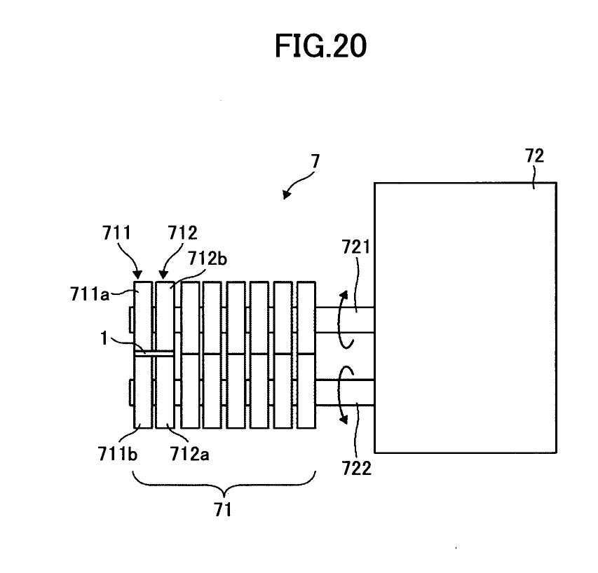

Next, a discharging device 7 (see FIG. 20) for applying the rotational force illustrated in FIG. 19 to the cleaning medium 1 to cause it scatter. FIG. 20 illustrates a configuration of such a discharging device 7. As illustrated in FIG. 20, the discharging device 7 includes a rotator unit 71 and a driver unit 72. The rotator unit 71 includes a high-speed rotational shaft 721 extending from the driver unit 72 and a low-speed rotational shaft 722, and high-speed rotators 711 and low-speed rotators 712 are attached to the high-speed rotational shaft 721 and the low-speed rotational shaft 722. The driver unit 72 is configured to apply rotational force indicated by corresponding arrows illustrated in FIG. 20 to the high-speed rotational shaft 721 and low-speed rotational shaft 722. The discharging device 7 includes four high-speed rotators 711 each including a pair of a high-speed driving rotator 711a and a high-speed driven rotator 711b.

The high-speed driving rotator 711a is fixed to the high-speed rotational shaft 721, and the high-speed driven rotator 711b is rotationally attached to the low-speed rotational shaft 722 at a position facing the high-speed driving rotator 711a. With this configuration, the high-speed driving rotator 711a rotates with the rotation of the high-speed rotational shaft 721, and the high-speed driven rotator 711b is rotationally driven at a high speed simultaneously with the rotation of the high-speed driving rotator 711a when the cleaning medium 1 is sandwiched between the high-speed driving rotator 711a and the high-speed driven rotator 711b as described later.

Likewise, the discharging device 7 includes four low-speed rotators 712 each include a pair of a low-speed driving rotator 712a and a low-speed driven rotator 712b. The low-speed driving rotator 712a is fixed to the low-speed rotational shaft 722, and the low-speed driven rotator 712b is rotationally attached to the high-speed rotational shaft 721 at a position facing the low-speed driving rotator 712a. With this configuration, the low-speed driving rotator 712a rotates with the rotation of the low-speed rotational shaft 722, and the low-speed driven rotator 712b is rotationally driven at a low speed simultaneously with the rotation of the low-speed driving rotator 712a when the cleaning medium 1 is sandwiched between the low-speed driving rotator 712a and the low-speed driven rotator 712b as described later.

A distance between the high-speed rotational shaft 721 and the low-speed rotational shaft 722 is provided such that the cleaning medium 1 is sandwiched between the high-speed driving rotator 711a and the high-speed driven rotator 711b and between the low-speed driving rotator 712a and the low-speed driven rotator 712b, so that a rotational force of the rotators 711a, 711b, 712a, and 712b is transmitted to the cleaning medium 1, and a translational force is applied to the cleaning medium 1 to discharge the cleaning medium 1.

The four high-speed rotators 711 each including a pair of the high-speed driving rotator 711a and the high-speed driven rotator 711b and the four low-speed rotators 712 each including a pair of the low-speed driving rotator 712a and the low-speed driven rotator 712b are alternately arranged on the corresponding high-speed rotational shaft 721 and the corresponding low-speed rotational shaft 722.

A total width of the high-speed rotator 711 including a pair of the high-speed driving rotator 711a and the high-speed driven rotator 711b and the low-speed rotator 712 including a pair of the low-speed driving rotator 712a and the low-speed driven rotator 712b is configured to approximately be the same length or be slightly longer than the length of the cleaning medium 1 such that a high-speed rotational force and a low-speed rotational force are simultaneously applied to the cleaning medium 1 when the cleaning medium 1 is sandwiched between the high-speed driving rotator 711a and the high-speed driven rotator 711b of the high-speed rotator 711 and between the low-speed driving rotator 712a and the low-speed driven rotator 712b of the low-speed rotator 712. Note that the cleaning medium 1 may be sandwiched between the three rotators. However, in such a case, since areas of both the ends of the cleaning medium 1 sandwiched between the rotators differ, the rotational force may be biased in one direction.

Accordingly, the cleaning medium 1 supplied to the discharging device 7 rotationally discharged by the application of the forces applied to the two different points of the cleaning medium 1 at two different (high and low) speeds in the same direction as illustrated in FIG. 19.

Note that since the high-speed driving rotator 711a, the high-speed driven rotator 711b, the low-speed driving rotator 712a and the low-speed driven rotator 712b sandwich the cleaning medium 1 to apply the respective rotational speeds to the cleaning medium 1, they preferably have elasticity in order to obtain an appropriate pressure-contact condition or to absorb the difference in the number of cleaning media 1 sandwiched between them. Alternatively, one of the high-speed driving rotator 711a and the high-speed driven rotator 711b, or one of the low-speed driving rotator 712a and the low-speed driven rotator 712b may be configured to have elasticity.

In order to elastically pressure-contact the high-speed driving rotator 711a with the high-speed driven rotator 711b, and the low-speed driving rotator 712a with the low-speed driven rotator 712b, one or both of the high-speed rotational shaft 721 and the low-speed rotational shaft 722 may be made of an elastic material. Alternatively, an elastic member is provided between the high-speed rotational shaft 721 and the low-speed rotational shaft 722 in order to apply the elastic force between them.

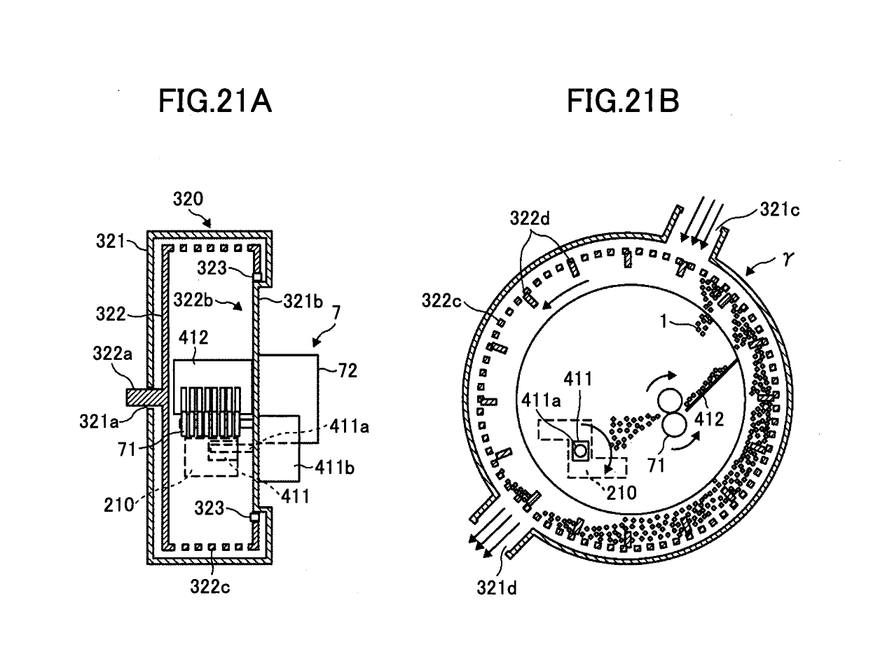

Next, the cleaning apparatus according to the third apparatus embodiment capable of applying the rotational force to the cleaning medium to discharge the cleaning medium 1 is described. FIG. 21A is a sectional side view and FIG. 21B is a front sectional view illustrating a configuration of the cleaning apparatus according to the third embodiment. A cleaning tank 320 includes an outer cylinder 321 arranged in a horizontal direction and an inner cylinder 322 smaller than the outer cylinder 312 arranged inside the outer cylinder 321.

As illustrated in FIG. 21A, an inner cylinder rotational shaft 322a is provided in a center of a first side surface of the inner cylinder 322, and a through-hole 321a configured to allow the inner cylinder rotational shaft 322a to pass through is provided in a center of a first side surface of the outer cylinder 321 located at the same side as the first side surface of the inner cylinder 322. The inner cylinder rotational shaft 322a is rotationally supported in the through-hole 312a. Further, a round opening 322b is formed in a second side surface (i.e., right side in FIG. 21A) of the inner cylinder 322 and a internally projected surface 321b is formed in a side surface of the outer cylinder 321 at the same side as the second side surface of the inner cylinder 322. The internally projected surface 321b of the outer cylinder 321 is rotationally fitted in the round opening 322b of the inner cylinder 322. A sealing member 323 such as a brush is slidably provided in a gap between the round opening 322b of the inner cylinder 322 and the internally projected surface 321b of the outer cylinder 321 so as not to leak the cleaning media 1 from the gap. Thus, the inner cylinder 322 is rotationally supported inside the outer cylinder 321, such that a not shown rotational driver unit rotationally drives the inner cylinder 322 via the inner cylinder rotational shaft 322a in a direction indicated by an arrow (i.e., in a counterclockwise direction) in FIG. 21B.

Meshed separation members 322c and transfer plates 322d are formed over an entire peripheral surface of the inner cylinder 322. Similar to the separation members used in the cleaning apparatus according to other embodiments, the separation members 322c includes numerous pores to discharge the removed adherent substances and small pieces of broken cleaning media 1 from the inner cylinder 322. The ribbed transfer plated 322d are formed at regular intervals in an inner surface of the inner cylinder 322 such that the ribbed transfer plates 322d transfer the cleaning media 1 when the inner cylinder 322 is rotated.

An inlet port 321c to introduce the airflow is provided at an obliquely upward position of the outer cylinder 321 and a suction port 321d to suction the airflow is provided at an obliquely downward position of the outer cylinder 321. The inlet port 321c is connected to a not shown compressed air supply device, and the suction port 321d is connected to a not shown suction device. Accordingly, in the inner cylinder 322, the airflow flowing in a direction from an upper position to a lower position is formed, while the airflow to cause the adherent substances or the like to pass through the separation members 322c is formed.

The inner cylinder 322 includes the rotator unit 71 of the discharging device 7, a holding fixture 411 for holding the cleaning target object 210, and a slide plate 412. These are attached inside the internally projected surface 321b of the outer cylinder 321.

The discharging device 7 used in the cleaning apparatus according to the third embodiment is that illustrated in FIG. 20. As illustrated in FIGS. 21A and 21B, the rotator unit 71 is arranged inside the inner cylinder 322 and the driver unit 72 is arranged outside the internally projected surface 321b. The holding fixture 411 is configured to hold or pressure-contact the cleaning target object 210 from inside the inner cylinder 322. The holding fixture 411 includes a rotational shaft 411a that is connected to a cleaning target object rotating unit 411b arranged outside the internally projected surface 321b.

The slide plate 412 is arranged at an upper position inside the internally projected surface 321b and is configured to slidably guide the cleaning media 1 in a direction toward the rotator unit 71 of the discharging device 7. The slide plate 412, the rotator unit 71, and the holding fixture 411 are arranged in approximately the same oblique line. The holding fixture 411 is situated nearer in relation to the suction port 321d. In the cleaning apparatus according to the third embodiment, the cleaning media 1 are accumulated around the transfer plates 322d located near the bottom surfaces of the separation members 322c, such that the cleaning media 1 are transferred by the transfer plates 322d in an upward direction. Thereafter, when the cleaning media 1 are transferred to the upper position to some extent (e.g., γ position), they are downwardly moved due to the effect of gravity or airflow. Part of the downwardly moved cleaning media 1 fall on the slide plate 412, slide on the surface of the slide plate, and are supplied to the rotator unit 71 of the discharging device 7. The discharging device 7 rotationally discharges the cleaning media 1 toward the cleaning target object 210, thereby cleaning the cleaning target object 210. Part of the downwardly moved cleaning media 1 are carried by the airflow and directly collide with the cleaning target object 210, thereby also cleaning the cleaning target object 210. The adherent substances removed from the cleaning target object 210 are suctioned by the suction unit via the suction port 321d and thus collected. When the cleaning target object 210 is cleaned, the cleaning target object 210 is rotated by the cleaning target object rotating unit 411b, thereby cleaning the entire cleaning target object 210.

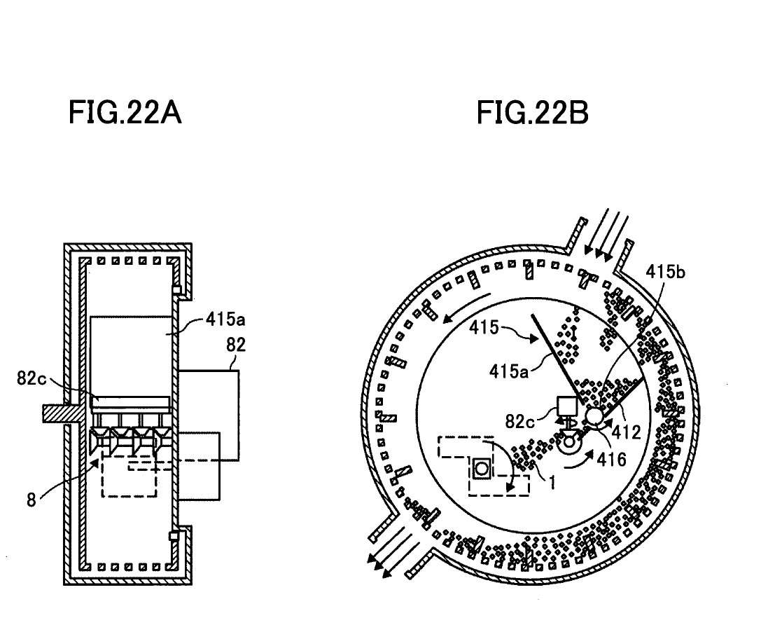

Next, a cleaning apparatus according to a fourth apparatus embodiment capable of applying the rotational force to the cleaning medium to discharge the cleaning medium 1 is described. FIG. 22A is a sectional side view and FIG. 22B is a front sectional view illustrating a configuration of the cleaning apparatus according to the fourth embodiment. Configurations of a discharging device 8 and a guide unit 415, and an additional cleaning media feeding roller 416 provided in the cleaning apparatus according to fourth embodiment illustrated in FIGS. 22A and 22B differ from the cleaning apparatus according to the third embodiment illustrated in FIGS. 21A and 21B. Other components are the same as those described in the third embodiment in FIGS. 21A and 21B and the descriptions thereof are thus omitted.

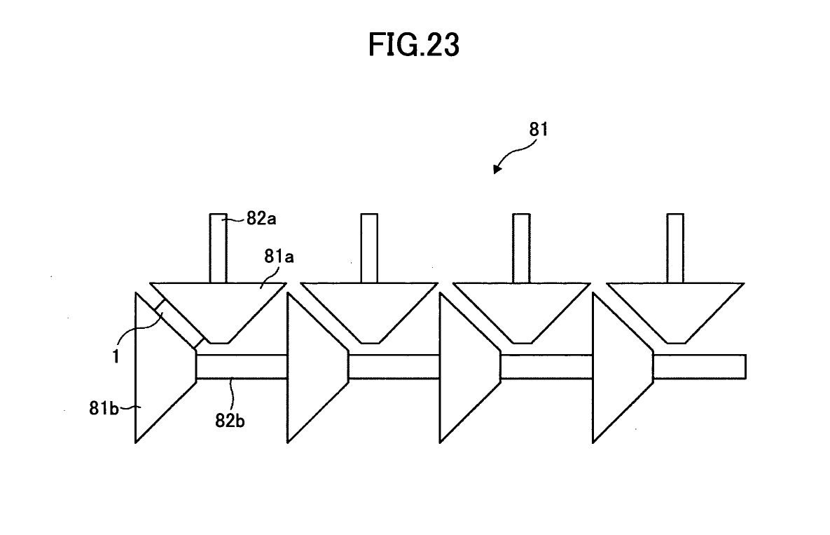

The discharging device 8 used in the cleaning apparatus according to the fourth embodiment is described below. The discharging device 8 includes rotators having a conical structure. FIG. 23 illustrates a configuration of a rotator unit 81 of the discharging device 8. As illustrated in FIG. 23, the rotator unit 81 includes four pairs of a driving rotator 81a and a driven rotator 81b. The driving rotator 81a is fixed to a rotational shaft 82a extending from an upper side to a lower side and arranged to a downward direction. A driver unit 82 transmits a drive force to the rotational shaft 82a via a drive force transmission unit 82c, thereby driving the driving rotator 81a. The driven rotator 81b is rotationally fixed to a fixed shaft 82b and arranged in a horizontal direction perpendicular to the rotational shaft 82a such that a slant surface of the driven rotator 81b faces that of the driving rotator 81a. Accordingly, the driving rotator 81a rotates with the rotation of the rotational shaft 82a, and the driven rotator 81b is rotationally driven simultaneously with the rotation of the driving rotator 82a when the cleaning medium 1 is sandwiched between the slant surface of the driving rotator 82a and the slant surface of the driven rotator 81b.

With this configuration, a radius of gyration varies with positions in a conic generatrix of the driving rotator 81a, so that a peripheral speed of the driving rotator 81a while rotating also varies with the positions in the conic generatrix of the driving rotator 81a. Accordingly, when the cleaning medium 1 is sandwiched between the slant surface of the driving rotator 81a and the slant surface of the driven rotator 81b, the rotational speed applied to the cleaning medium 1 varies with positions of the cleaning medium 1 sandwiched between the slant surface of the driving rotator 81a and the slant surface of the driven rotator 81b, thereby providing a speed difference between the positions of the cleaning medium 1. Accordingly, a rotational force is applied to the cleaning medium 1, thereby rotating the cleaning medium 1 as illustrated in FIG. 19.

The guide unit 415 provided as a hopper in the cleaning apparatus according to the fourth embodiment includes the slide plate 412, a receiver plate 415a to receive the cleaning media 1 arranged in front of the slide plate 412, and a supply port 415b formed by arranging the slide plate 412 and the receiver plate 415a to narrow down a gap in-between. The cleaning media 1 are supplied to the rotator unit 81 of the discharging unit 8 via the supply port 415b.

Further, the cleaning apparatus according to the fourth embodiment includes the cleaning media feeding roller 416. The cleaning media feeding roller 416 is provided at the supply port 415b, and the cleaning media 1 are efficiently supplied to the rotator unit 81 of the discharging device 8 by the rotation of the cleaning media feeding roller 416 while the cleaning apparatus is in operation. The cleaning media 1 are then rotationally discharged by the discharging device 8 toward the cleaning target object 210, so that the cleaning media 1 clean the cleaning target object 210.

Note that similar to the discharging device 7 illustrated in FIG. 20, in the discharging device 8 illustrated in FIG. 23, adequate elasticity may be provided in the respective surfaces of the driving rotator 81a and the driven rotator 81b that sandwich the cleaning medium 1 or an elastic force may be provided between the rotational shafts 82a and 82b.

The cleaning apparatus according to the aforementioned embodiments is configured to allow the flexible flake cleaning media each having the abrasive grains in at least one of its surfaces to contact the cleaning target object to abrade the adherent substances off the cleaning target object. Accordingly, the cleaning apparatus may efficiently remove the adherent substances such as rust strongly adhering to a surface of the cleaning target object even if the cleaning target object has a complex structure.

The present invention is not limited to the specifically disclosed embodiments, and variations and modifications may be made without departing from the scope of the present invention.

This patent application is based on Japanese Priority Patent Application No. 2009-257958 filed on Nov. 11, 2009, the entire contents of which are hereby incorporated herein by reference.

1-12. (canceled)

13. A cleaning apparatus comprising:
a cleaning tank having a space to contain plural flexible flake cleaning media;
a cleaning target object holding unit configured to hold a cleaning target object having adherent substances adhering thereto inside the cleaning tank;
a gas flow generator unit configured to generate a gas flow to move the plural flexible flake cleaning media toward the cleaning target object such that the plural flexible flake cleaning media contact the cleaning target object to remove the adherent substances from the cleaning target object;
an adherent substance collection unit configured to move the gas flow to collect the adherent substances removed from the cleaning target object;
a binder layer provided on at least one surface of each of the flexible flake cleaning media where the abrasive grains are provided, the abrasive grains being fixed in the binder layer provided on the at least one surface of the flexible flake cleaning media; and
a substrate on which the binder layer is provided,
wherein a bonding power of the binder layer to the substrate is higher than a cohesive power of the binder layer, and
wherein the abrasive grains fixed in the binder layer provided on the at least one surface of the flexible flake cleaning media remove the adherent substances from the cleaning target object by causing the at least one surface of the flexible flake cleaning media having the abrasive grains to slide on the cleaning target object while the at least one surface of the flexible flake cleaning media having the abrasive grains is in contact with the cleaning target object.

14. The cleaning apparatus as claimed in claim 13, further comprising:
a circulation unit configured to move the cleaning media toward the cleaning target object and subsequently return the cleaning media to a start position where the cleaning media have started to move toward the cleaning target object.

15. The cleaning apparatus as claimed in claim 14,
wherein the circulation unit returns the cleaning media to the start position where the cleaning media have started to move toward the cleaning target object by causing the gas flow generated by the gas generator unit to swing backward from an inner surface of the cleaning tank.

16. The cleaning apparatus as claimed in claim 14,
wherein the adherent substance collection unit is provided in a path where the cleaning media are returned to a start position where the cleaning media have started to move toward the cleaning target object by the gas flow after having moved toward the cleaning target object.

17. A cleaning apparatus comprising:
a cleaning tank having a space to contain plural flexible flake cleaning media;
a cleaning target object holding unit configured to hold a cleaning target object to which adherent substances adhere inside the cleaning tank;
a gas flow generator unit configured to generate a gas flow to move the plural flexible flake cleaning media toward the cleaning target object such that the plural flexible flake cleaning media contact the cleaning target object to remove the adherent substances from the cleaning target object;
an adherent substance collection unit configured to move the gas flow to collect the adherent substances removed from the cleaning target object;
a binder layer provided on at least one surface of each of the flexible flake cleaning media where the abrasive grains are provided, the abrasive grains being fixed in the binder layer provided on the at least one surface of the flexible flake cleaning media; and
a substrate on which the binder layer is provided,
wherein a bonding power of the binder layer to the substrate is higher than a cohesive power of the binder layer, and
wherein the at least one surface of each of the flexible flake cleaning media includes abrasive grains to remove a part of the adherent substances from the cleaning target object by causing the at least one surface of the flexible flake cleaning media having the abrasive grains to slide on the cleaning target object while the at least one surface of the flexible flake cleaning media having the abrasive grains is in contact with the cleaning target object, and
wherein a part of the adherent substances is removed from the cleaning target object by allowing the flexible flake cleaning media to collide with the cleaning target object.

18. A cleaning medium comprising:
a flexible flake medium and abrasive grains provided in at least one surface of the flexible flake medium;
a binder layer provided on the at least one surface of the flexible flake medium where the abrasive grains are provided, the abrasive grains being fixed in the binder layer provided on the at least one surface of the flexible flake medium; and
a substrate on which the binder layer is provided,
wherein a bonding power of the binder layer to the substrate is higher than a cohesive power of the binder layer, and
wherein the flexible flake medium having the at least one surface provided with the abrasive grains moves toward a cleaning target object having adherent substances arranged in a space to remove the adherent substances from the cleaning target object while the flexible flake medium having the at least one surface provided with the abrasive grains is in contact with the cleaning target object having the adherent substances.

19. The cleaning medium as claimed in claim 18,
wherein the flexible flake medium is made of a material having brittle fracture properties.

20. The cleaning medium as claimed in claim 18,
wherein the binder layer includes cutout portions.

21. The cleaning medium as claimed in claim 18 comprising an accordion-like structure.

22. The cleaning medium as claimed in claim 18 comprising a three-dimensional structure.
